(19) United States
(12) Patent Application Publication
(10) Pub. No.: US 2026/0205030 A1
(43) Pub. Date: Jul. 16, 2026

(54) MOF COMPOSITE

(71) Applicant: Oxford University Innovation Limited, Oxford (GB)

(72) Inventors: Jin-Chong TAN, Oxford (GB); Jiahao YE, Oxford (GB)

(21) Appl. No.: 19/136,548

(22) PCT Filed: Dec. 15, 2023
(86) PCT No.: PCT/GB2023/053275

§ 371 Date: Jun. 6, 2025

(30) Foreign Application Priority Data
Dec. 16, 2022 (GB) 2219095.3

(51) Int. Cl. H02N 1/04; C07F 3/06; C08K 5/56; H02J 50/00

(52) U.S. Cl. CPC H02N 1/04; C07F 3/06; C08K 5/56; H02J 50/001

(57) ABSTRACT

The present invention relates to a transducer for converting mechanical or kinetic energy to electrical energy, wherein the transducer comprises a composite material, wherein the composite material comprises a polymer matrix and, dispersed in the matrix, a metal organic framework (MOF), wherein the metal organic framework comprises a metal ion and an organic linker, wherein the organic linker comprises one or more electronegative substituents.

### FIELD OF THE INVENTION

The invention relates to a transducer for converting mechanical or electrical energy to kinetic energy, wherein the transducer comprises a composite material comprising a polymer matrix and a metal organic framework (MOF).

### BACKGROUND TO THE INVENTION

Triboelectric nanogenerator (TENG) is an evolving technology first proposed by Wang et al. in 2012 (F.-R. Fan, et al., Nano Energy, 2012, 1, 328-334). As a simple and cost-effective energy generating device, TENG is capable of transforming mechanical motions into electric energy which can be harvested for a variety of scenarios, including self-powered sensors (X. Guan, et al., Nano Energy, 2020, 70, 104516; Z. Li, et al., Research (Wash D C), 2020, 2020, 8710686; Y. Su, et al., ACS Nano, 2020, 14, 6067-6075; D. Wang, et al., ACS Nano, 2021, 15, 2911-2919; S. Mishra, et al., Mater. Today. Commun., 2022, 31, 103292) and energy harvesters (X. Ren, et al., Nano Energy, 2018, 50, 562-570; X. Chen, et al., Nano Energy, 2019, 64, 103904; L. Long, et al., Nat. Commun., 2021, 12, 4689; R. Walden, et al., Chem. Eng. J. Adv., 2022, 9, 100237). These applications are acting essential roles in the development of cutting-edge technologies such as the Internet of Things (IoT),(T. Jin, et al., Nat. Commun., 2020, 11, 5381) wearable electronics (S. Dong, et al; Nano Energy, 2020, 78, 105327; F. Xu, et al., Nano Energy, 2021, 88, 106247), and artificial intelligence (AI) (Y. Zhou, et al., Nano Energy, 2021, 84, 105887; M. Chen, et al., Nano Energy, 2022, 92, 106783).

Although the concept of TENG was first introduced in the last decade, the triboelectric effect, a fundamental physical phenomenon in the real world, has been observed for thousands of years, and a number of research have been done to investigate the theory behind it (S. Pan et al., Friction, 2019, 7, 2-17; S. Pan et al., J. Appl. Phys., 2017, 122, 144302; D. J. Lacks et al., J. Phys. D-Appl. Phys., 2011, 44, 453001). Currently, the selection of materials for triboelectric nanogenerators is commonly referred to the triboelectric series first published by AlphaLab Inc in 2009, ranked by the ability to attract or repel electrons through empirical results (J. Chen et al., Joule, 2017, 1, 480-521). For the tribo-positive materials, metals like copper and aluminium are the conventional options attributed to their excellent electron-donating properties (R. Zhang et al., EcoMat, 2020, 2, 12062). On the other hand, for the tribo-negative materials, fluorinated polymers dominate the triboelectric series due to their high electronegativity and surface charge density (Y. S. Choi, et al., Adv. Energy Mater., 2021, 11, 2003802). Despite these materials having been present in the series for well over a decade, the practical applications of TENGs are still limited by the low power output. Therefore, it is imperative to develop new triboelectric materials beyond the conventional triboelectric series to overcome the current bottleneck.

Through years of development, various strategies have been proposed to improve the electrical performance of TENG, including material surface modification (X. Chen, et al., Nano Energy, 2019, 64, 103904; Y. S. Choi, et al., Adv. Energy Mater., 2021, 11, 003802), incorporation of filler materials as charge traps (R. Wen, et al., Nano Energy, 2018, 50, 140-147), and amplification of material's dielectric constant (J. Chen, et al., ACS Appl. Mater. Interfaces, 2016, 8, 736-744). Among all approaches, addition of nanoparticles as a filler material into conventional triboelectric materials is considered as the most convenient and effective to improve the triboelectric properties of a material from all of the above aspects. A variety of materials have been studied to improve the operating performance and the robustness of TENG such as perovskites (M. Sahu, et al., Mater. Today Energy, 2021, 20, 100639), MXenes (M. Salauddin, et al., Adv. Energy Mater., 2021, 11, 2002832), graphene (B. N. Chandrashekar, et al., Adv. Mater., 2015, 27, 5210-5216), carbon nanotubes (M. Su et al., ACS Appl. Nano Mater., 2020, 3, 9759-9770), etc.

Recently, metal organic framework (MOF) material has gained tremendous attention due to its organic-inorganic hybrid structure. MOF is a class of material fabricated by the self-assembly of metal ions and organic linkers with formation of well-structured nanopores and high surface areas. The high flexibility and tunability of MOF enable functionalization of its structure for different applications such as sensing (I. Stassen, et al., Chem. Soc. Rev., 2017, 46, 3185-32410), luminescence (M. Gutierrez, et al., Chem. Rev., 2022, 122, 10438-10483), catalysis (J. Lee et al., Chem. Soc. Rev., 2009, 38, 1450-1459), and gas adsorption (J. R. Li, et al., Chem. Soc. Rev., 2009, 38, 1477-1504). Likewise, these excellent properties can be leveraged for improving the output performance of TENG by tuning the dielectric constants (A. S. Babal, et al., J. Phys. Chem. C, 2019, 123, 29427-29435; K. Titov, et al., J. Phys. Chem. Lett., 2017, 8, 5035-5040), improving the surface charge density or controlling the surface roughness.

In 2019, Wen et al. first developed a humidity resistive TENG by incorporating HKUST-1 within the PDMS polymer matrix (R. Wen, et al., Adv. Funct. Mater., 2019, 29, 1807655). Due to the remarkable electron trapping capacity and high dielectric constant of HKUST-1, the power output of prepared TENG increased by 13 times compared to that of TENG without MOF. Moreover, Jayababu and Kim fabricated a bimetal organic framework (BMOF) containing both cobalt and zinc metal ions which proves to have enhanced TENG power output (N. Jayababu et al., Nano Energy, 2021, 89, 106355). Ascribed to the tunable sensing properties of MOF materials, the fabricated TENG was tested to be employed as an ammonia sensor with great selectivity and durability. Besides, Rana et al. carbonized ZIF-67 to form a cobalt-containing nanoporous carbon (Co-NPC) and used it as a filler material in the charge generating layer in a non-contact mode TENG (S. M. S. Rana, et al., Adv. Funct. Mater., 2021, 31, 2105110). A filler loading of 3 wt % in the Ecoflex matrix improved the power output by 2 times due to the high porosity and charge trapping capacity of MOF. Later in 2021, Wen et al. further reported the approach of using ZIF-8 as fillers in PDMS matrix (R. Wen, et al., Nanotechnology, 2021, 32, 345401). The addition of ZIF-8 nanoparticles was found to increase the TENG output up to 176 V and 16.3 μA, over 2 times higher than that without ZIF-8.

### SUMMARY OF THE INVENTION

The present inventors have found that MOFs in which the organic linker comprises one or more electronegative substituents are excellent fillers for TENG applications. By incorporating such MOFs into a polymer matrix, TENG devices with much enhanced electrical performance can be fabricated. Both the charge generating and the charge trapping properties of the MOFs contributed to the improvement of the output performance. In particular, the presence of an electronegative substituent in the ligand of the MOF induced high electronegativity, hence improving the charge generating capability of the MOF/polymer composite. In addition, the high surface-to-volume ratio of the MOFs incorporated in the polymer matrix created a larger effective contact area which behaves as charge traps to draw electrons deeper into the film, creating more opportunities for charge transfer.

For instance, zeolitic imidazolate framework (ZIF) MOFs in which the organic linker comprises at least one electronegative substituent, such as ZIF-71, and its non-porous form, ZIF-72, have been found to be excellent nanofillers for TENG applications, as demonstrated in the Examples herein. Modified ZIF-8 (i.e. ZIF-8 with electronegative substituents added, in particular halogenated ZIF-8) has also been found to be an excellent nanofiller. ZIF-71, for example, has advantages such as ease of synthesis, moderate particle size, high resistance to humidity, and excellent nanoporosity. ZIF-72, due to its dense structure and unconventional synthesis condition, was rarely studied in literature, yet its unique properties such as higher dielectric constant and excellent environmental stability were deemed by the present inventors to potentially be favourable for TENG applications.

By incorporating the above-mentioned MOF nanoparticles into PDMS or PVDF matrix, TENG devices with much enhanced electrical performance were fabricated. The present inventors have surprisingly found that use of substantially non-porous MOF materials can provide improved electrical performance of TENG. The charge generating and charge trapping properties of MOF nanoparticles both contributed to the improvement of the output performance. The chlorine atoms in the ligands of ZIF-71 and ZIF-72 induced high electronegativity, to enhance the charge-generating capability as discussed above. In addition, the high surface-to-volume ratio of these MOFs enhanced the effective contact area to create more opportunities for charge transfer. The effects of physical properties such as porosity, dielectric constant, hydrophobicity, and surface roughness on the output performance were also analyzed to establish further general design criteria for the selection of MOF in TENG. As a result, the prepared TENG devices fabricated by MOF/polymer nanocomposites both showed improved electrical output performance compared with neat polymer, with devices achieving exceptionally high open-circuit voltage and short-circuit currents of, for instance, 578 V and 19 μA respectively, which are 2.8 times and 4.2 times higher respectively than those of pristine polymer TENG. In addition, an instantaneous power density of 5.03 W m-2 was reached under an external load resistance of 20 MΩ.

Additionally, the electrical energy from the devices of the invention was harvested to power small electronics such as LEDs, capacitors, and smartwatches. A prototype for a pedometer that can transmit signals remotely via Bluetooth was also designed to demonstrate the practical potential of using MOF/polymer TENGs of the invention as a self-powered sensor.

Accordingly, the present invention provides a transducer for converting mechanical or kinetic energy to electrical energy, wherein the transducer comprises a composite material, wherein the composite material comprises a polymer matrix and, dispersed in the matrix, a metal organic framework (MOF), wherein the metal organic framework comprises a metal ion and an organic linker, wherein the organic linker comprises one or more electronegative substituents.

The transducer of the invention is typically a triboelectric generator, wherein the triboelectric generator comprises: (i) a tribo-negative element; and (ii) a first electrode, wherein the first electrode is arranged to receive charge resulting from relative movement between the tribo-negative element and a tribo-positive element, and wherein the tribo-negative element comprises said composite material.

The invention also provides a composite material which comprises a polymer matrix and, dispersed in the matrix, a metal organic framework, wherein the metal organic framework comprises a metal ion and an organic linker, wherein the organic linker comprises one or more electronegative substituents.

The invention also provides an electrical generator which comprises a transducer as described anywhere herein. The electrical generator is typically a generator of electrical power. The electrical power may be for storage and/or for use in powering or charging a product.

Also provided by the invention is a product comprising an electrical generator as described anywhere herein, wherein the product is an electronic device, for instance a wearable electronic device, microelectronics, a humidity thermometer, a digital timer, or a calculator; a charging device, for instance a phone charger; a capacitor; a light emitting diode; a transmitter, for instance a Bluetooth transmitter.

The invention also provides an electrical generator which comprises a transducer of the invention, wherein the transducer is a triboelectric generator, wherein the triboelectric generator comprises a tribo-negative element; and a first electrode, arranged to receive charge resulting from relative movement between the tribo-negative element and a tribo-positive element, wherein the tribo-negative element comprises said composite material, and wherein the relative movement comprises sliding a surface of the tribo-negative element against a surface of the tribo-positive element, wherein the sliding comprises rotational sliding, and wherein the relative movement is caused by wind and/or wave. The relative movement may be caused by wind, and the wind may be generated by a passing vehicle, for instance a train. Typically, the counter-electrode is said tribo-positive element. Alternatively, the triboelectric generator may further comprise said tribo-positive element, and the tribo-positive element is attached to the counter-electrode.

The invention also provides a device comprising an electrical generator which comprises a transducer of the invention, wherein the transducer is a triboelectric generator, wherein the triboelectric generator comprises a tribo-negative element; and a first electrode, arranged to receive charge resulting from relative movement between the tribo-negative element and a tribo-positive element, wherein the tribo-negative element comprises said composite material, wherein the triboelectric generator further comprises a counter-electrode, wherein the tribo-negative element is not in contact with the first electrode and is not in contact with the counter electrode, and the first electrode and the counter-electrode are the tribo-positive element, wherein the relative movement comprises moving the tribo-negative element relative to the first electrode and the counter-electrode to arrange the tribo-negative element alternately (i) closer towards the first electrode and further away from the counter-electrode, and (ii) closer towards the counter-electrode and further away from the first electrode, wherein said moving comprises rotational movement. Usually the device is a machine capable of rotary motion, for instance a washing machine, tumble dryer, or combined washer dryer.

The invention also provides a device comprising an electrical generator which comprises a transducer of the invention, wherein the transducer is a triboelectric generator, wherein the triboelectric generator comprises a tribo-negative element; and a first electrode, arranged to receive charge resulting from relative movement between the tribo-negative element and a tribo-positive element, wherein the tribo-negative element comprises said composite material, and wherein the relative movement comprises sliding a surface of the tribo-negative element against a surface of the tribo-positive element, wherein the sliding comprises rotational sliding, and optionally wherein the device is a machine capable of rotary motion, for instance a washing machine, tumble dryer, or combined washer dryer.

Also provided by the invention is a sensor which comprises a transducer of the invention.

The invention also provides a product which comprises at least one transducer of the invention, wherein the product is a keyboard, a morse code generator, a dance floor, sportswear, a biomedical implant, or a prosthetic, optionally wherein the product is self-powered.

The invention also provides a gas filtration device which comprises a composite material of the invention.

A water purification device which comprises a composite material of the invention is also provided.

In addition, the invention provides a catalyst which comprises a composite material of the invention.

The invention also provides a luminescent device which comprises a composite material of the invention.

Also provided by the invention is a method of operating a triboelectric generator of the invention, wherein the method comprises: causing the relative movement between the tribo-negative element and the tribo-positive element, in order to generate a potential difference between them due to a triboelectrification effect.

### BRIEF DESCRIPTION OF THE FIGURES

FIG. 1 shows schematic diagram of the working mechanism of (1) contact-separation mode, (2) lateral sliding mode, (3) single-electrode mode, and (4) free-standing mode.

FIG. 2 shows (a) the crystal structure of a ZIF-71 unit cell, (b) AFM topography of ZIF-71 single-crystal, (c) the crystal structure of a ZIF-72 unit cell, (d) AFM topography of a ZIF-72 single crystal, (e and f), XRD patterns of as-synthesized ZIF-71 and ZIF-72 were generated from the crystallographic information file (CIF) obtained from the Cambridge Structural Database (CCDC code: GITVIP and GIZJUV), (g and h) FTIR spectra of the as-synthesized ZIF-71 and ZIF-72 nanoparticles in the mid-IR and far-IR regions respectively.

FIG. 3 shows (a) XRD patterns of ZIF-71 embedded PDMS thin films under different mass loadings, compared with ZIF-71 nanoparticle; and (b) XRD patterns of ZIF-72 embedded PDMS thin films under different mass loadings, compared with ZIF-72 nanoparticle.

FIG. 4 shows (a) FTIR spectra of ZIF-71 embedded PDMS thin films under different mass loadings, compared with ZIF-71 nanoparticle, (b) FTIR spectra of ZIF-72 embedded PDMS thin films under different mass loadings, compared with ZIF-72 nanoparticle, (c) FTIR spectra of ZIF-71/PDMS composites, superimposed between 1192 cm⁻¹ and 1210 cm⁻¹, (d) FTIR spectra of ZIF-72/PDMS composites, superimposed between 1182 cm⁻¹ and 1205 cm⁻¹.

FIG. 5 shows SEM images of ZIF-71/PDMS nanocomposites under a) 0 wt % loading, b) 2 wt % loading, and c) 5 wt % loading.

FIG. 6 shows SEM images of ZIF-72/PDMS nanocomposites under a) 0 wt % loading, b) 2 wt % loading, and c) 5 wt % loading.

FIG. 7 shows (a) schematic diagram of the working mechanism of a contact-separation mode TENG based on MOF-PDMS nanocomposite, (b) dielectric constant of ZIF-72/PDMS (1 wt %), ZIF-71/PDMS (2 wt %), and pristine PDMS films, measured from 4 Hz-8 MHz, (c) FEM simulation of the variation of electric potential on the triboelectric material surfaces of TENG under oscillatory contact and separation mode, (d) simulated electric potential of TENG on the top electrode as a function of the separation distance between the electrodes.

FIG. 8 shows dielectric constants of ZIF-71/PDMS films at room temperature from 4 Hz to 8 MHz.

FIG. 9 shows a) closed-circuit voltage, b) open-circuit current, and c) transferred charge of Z71-TENG at different mass loadings under an oscillatory motion of 2 Hz.

FIG. 10 shows a) closed-circuit voltage, b) open-circuit current, and c) transferred charge of Z72-TENG at different mass loadings under an oscillatory motion of 2 Hz.

FIG. 11 shows (a-c) comparison of electrical output performance including closed-circuit voltage, open-circuit current, and charge transfer between Z72-TENG (1 wt %), Z71-TENG (2 wt %), and P-TENG under 2 Hz oscillatory motion with 16 N impact force, (d-f) electrical output performance of Z72-TENG (2 wt %) at 16 N under different frequencies, (g-h) electrical output performance of Z72-TENG (2 wt %) at 2 Hz with varying impact force.

FIG. 12 shows (a) peak voltage, current, and power density of Z72-TENG across varying load resistances, (b) schematic of an electrical circuit designed for the practical application studies of Z72-TENG, (c) capacitor charging curves by operating Z72-TENG at 2 Hz for 0.1, 0.47. 1, 2.2 and 10 pF capacitors, (d) powering of a commercial calculator by Z72-TENG at connection times of 0, 15 and 30 s, (e) voltage profiles of discharging 47 μF capacitor by four different electronic devices, (f) illumination of 120 LEDs at 2 Hz by the electricity generated from Z72-TENG.

FIG. 13 shows (a) harvesting biomechanical energy by touching, tapping, and smashing a single electrode mode Z72-TENG, (b) schematic of a Z72-TENG based pedometer with Bluetooth transmission; number of taps being detected remotely and displayed on the screen of a mobile phone, (c) durability test of the Z72-TENG after a continuous running of 10,000 cycles, (d) water contact angles of pristine PDMS, ZF-71/PDMS and ZIF-72/PDMS films.

FIG. 14 shows testing of a prototype self-powered keyboard comprising a ZIF-72/PDMS composite.

FIG. 15 shows a) stable open-circuit voltage output of 1% Z71-TENG under 2 Hz. b) Zoomed-in view of a single peak voltage signal.

FIG. 16 shows the difference in illumination intensities of LEDs powered by PDMS based TENG and Z71- TENG.

FIG. 17 shows the durability of Z71-TENG after a continuous running of 5,000 cycles.

FIG. 18 shows changes in XRD patterns for (a) ZIF-71 and (b) ZIF-72 nanoparticles after 180 days. Both ZIF-71 and ZIF-72 shows excellent durability under ambient temperature and humidity that the XRD patterns were mostly retained, despite a peak broadening was observed for ZIF-71 nanoparticles.

FIG. 19 shows a) International Morse code table for the alphabet. b-e) Electrical signal of Z72-TENG encoding short messages, translated by a python program using the database.

FIG. 20 shows schematics illustrating the synthesis routes of ZIF-8 and its halogenated derivatives.

FIG. 21 shows XRD patterns of ZIF-8-X nanoparticles.

FIG. 22 shows ATR-FTIR spectra of ZIF-8-X nanoparticles.

FIG. 23 shows synchrotron FarIR spectra of ZIF-8-X nanoparticles.

FIG. 24 shows AFM topography of as-synthesised ZIF-8-X nanoparticles.

FIG. 25 shows nano-FTIR absorption spectra of as-synthesised ZIF-8-X nanoparticles.

FIG. 26 shows a schematic of an electrospinning procedure and parameters for the preparation of ZIF-8-X/PVDF composite fibre.

FIG. 27 shows SEM images of prepared ZIF-8-X/PVDF nanocomposite fibre.

FIG. 28 shows XRD patters of ZIF-8-X/PVDF composite fibre.

FIG. 29 shows FTIR spectra of ZIF-8-X/PVDF composites.

FIG. 30 shows superimposed FTIR spectra of ZIF-8-X/PVDF composites between 1100 cm⁻¹ and 1200 cm⁻¹.

FIG. 31 shows exploded view illustrating the structure of prepared ZIF-8-X/PVDF TENG devices.

FIG. 32 shows open-circuit voltage output of prepared TENG devices.

FIG. 33 shows closed-circuit current output of prepared TENG devices.

FIG. 34 shows output stability of ZIF-8-X/PVDF-based TENG over 100 cycles.

FIG. 35 shows the average peak-to-peak voltage output generated by ZIF-8-X/PVDF-based TENG.

FIG. 36 shows long-term durability of ZIF-8-Cl/PVDF-based TENG over continuous running of 40,000 cycles.

FIG. 37 shows voltage output of ZIF-8-Cl/PVDF-based TENG under varying frequencies.

FIG. 38 shows relationship between the force applied on ZIF-8-Cl/PVDF-based TENG and the output voltage on the same time scale.

FIG. 39 shows the relationship between the force applied on ZIF-8-X/PVDF-based TENG and the output voltage on the same time scale.

FIG. 40 shows voltage output of ZIF-8-Cl/PVDF-based TENG under varying forces.

FIG. 41 shows the voltage output of ZIF-8-Cl/PVDF-based TENG under varying forces.

FIG. 42 shows voltage profiles over different capacitors charged by 2 Hz operation of ZIF-8-Cl/PVDF-based TENG.

FIG. 43 shows capacitors with capacitances ranging from 0.1 μF to 10 μF were charged by Halogenated ZIF-8/PVDF based TENG.

FIG. 44 shows a comparison between charging speed on a 2.2 μF capacitor by different ZIf-8-X based TENGs.

FIG. 45 shows the comparison of peak power densities of prepared ZIF-8-X/PVDF TENG over a range of load resistances.

FIG. 46 shows the comparison of voltage produced by ZIF-8-X/PVDF TENG over a range of magnitudes of force.

FIG. 47 shows peak-to-peak voltage generated by ZIF-8-X/PVDF TENG tested under contact-separation mode.

FIG. 48 shows FTIR spectra of ZIF-8-X/PVDF membrane.

FIG. 49 shows zoomed in section of FTIR spectra of ZIF-8-X/PVDF membrane.

FIG. 50 shows an image of the rotary design non-contact mode set up.

FIG. 51 shows a front view of an electrode which may comprise a composite material as described herein.

FIG. 52 shows a still from an animation of the rotary design non-contacting mode.

FIG. 53 shows the working principle of the free-standing TENG.

FIG. 54 shows AC output profile from a rotary design non-contacting mode, rotated at 600 rpm-80 Hz.

FIG. 55 shows voltage produced by a non-contacting mode (i.e. free-standing mode) TENG on a rotor, at various different rotation speeds.

FIG. 56 shows current produced by a non-contacting mode (i.e. free-standing mode) TENG on a rotor, at various different rotation speeds.

FIG. 57 shows charge produced by a non-contacting mode (i.e. free-standing mode) TENG on a rotor, at various different rotation speeds.

FIG. 58 shows long-term output stability of a non-contacting mode (i.e. free-standing mode) TENG on a rotor.

FIG. 59 shows the variation of current generated by a non-contacting mode TENG rotor depending on the gap between the electrode and the MOF composite.

FIG. 60 shows the normalised current produced by a non-contacting mode TENG rotor depending on the gap between the electrode and the MOF composite. The curve shows an exponential decay.

FIG. 61 shows the variation of voltage generated by a non-contacting mode TENG rotor depending on the gap between the electrode and the MOF composite.

FIG. 62 shows the normalised voltage produced by a non-contacting mode TENG rotor depending on the gap between the electrode and the MOF composite. The curve shows an exponential decay.

FIG. 63 shows the set-up of an LED array powered by a non-contacting mode TENG rotor device.

FIG. 64 shows the voltage produced by a non-contacting mode TENG rotor device when in a circuit with different capacitors.

### DETAILED DESCRIPTION OF THE INVENTION

### Transducer

The present invention provides a transducer for converting mechanical or kinetic energy to electrical energy. The term “transducer” as used herein takes it normal meaning in the art, namely a device which converts energy from one form to the other. As discussed above, in the present invention the transducer is suitable for converting mechanical energy (for example rotary, oscillating, linear and reciprocating motion) or kinetic energy into electrical energy.

In the present invention, the transducer comprises a composite material, wherein the composite material comprises a polymer matrix and, dispersed in the matrix, a metal organic framework (MOF), wherein the metal organic framework comprises a metal ion and an organic linker, wherein the organic linker comprises one or more electronegative substituents.

A matrix, as used herein, refers to a material or structure in which another material is embedded. A matrix is typically a continuous material or structure. The material embedded in the matrix (i.e. the material dispersed in the matrix) is typically in the form of a plurality of discrete volumes. The matrix employed in the present invention is a polymer matrix. The other material which is embedded (i.e. dispersed within) the matrix employed in the present invention is the metal organic framework. Typically particles, for instance nanoparticles, of the MOF are dispersed in the matrix.

The term “metal organic framework” or “MOF” is known in the art, and takes its normal meaning herein. Thus, the term refers to a compound comprising metal ions coordinated to organic ligands to form an extended one-, two-, or three-dimensional structure. Often, the structure is an extended two- or three- dimensional structure. It may for instance be an extended three-dimensional structure.

### Triboelectric Generator

The transducer of the invention may be a triboelectric generator, wherein the triboelectric generator comprises a tribo-negative element; and a first electrode, arranged to receive charge resulting from relative movement between the tribo-negative element and a tribo-positive element. The tribo-negative element comprises the composite material. Thus, the tribo-negative element comprises the polymer matrix and, dispersed in the matrix, the MOF, which MOF comprises a metal ion and an organic linker, wherein the organic linker comprises one or more electronegative substituents. The composite material may comprise fibres which comprise said polymer matrix and, dispersed in the matrix, said MOF. The fibres may be electrospun fibres (i.e. they may have been produced by electrospinning). Thus, the tribo-negative element may comprise said fibres.

The triboelectric generator may be a triboelectric nanogenerator (TENG).

A triboelectric generator as used herein, takes its normal meaning in the art. In particular a triboelectric device is a device relying on motion-generated surface charge transfer between materials with different affinities. If two materials with different electron affinities make contact, the resulting charge transfer causes the material which gain charge to become negatively charged, and the other material which loses charge becomes positively charged. This is known as contact electrification. When the two materials are separated, if there is no conducting path between the two surfaces, then these surfaces are able to maintain their induced charges as static electricity. This process is known as electrostatic induction. A periodic potential difference (i.e. voltage) can thus be generated across the materials as a result of a periodic relative motion between the two. This is known as a triboelectrification effect.

A triboelectric generator (i.e. a triboelectric energy harvester), is therefore a device capable of harvesting electrical energy produced by a triboelectrification effect.

The term “tribo-negative element”, as used herein, takes its normal meaning in the art and refers to an element of the triboelectric generator which is made of a material that is closer to the negative end of the tribo-electric series than the material of the tribo-positive element.

Similarly, the term “tribo-positive element”, as used herein, takes its normal meaning in the art and refers to an element which is made of a material that is closer to the positive end of the tribo-electric series than the material of the tribo-negative element.

Materials which are close to the positive end of the tribo-electric series are typically electron-donating materials. Materials which are close to the negative end of the tribo-electric series are typically electron-accepting materials. A tribo-negative element can therefore accept electrons from the tribo-positive element in the same device, i.e. electrons are donated from the tribo-positive element to the tribo-negative element. The tribo-negative element as used herein comprises the composite material described herein.

A transducer comprising a triboelectric generator according to the invention may further comprise a counter-electrode. Often said counter-electrode is said tribo-positive element.

Thus, the tribo-positive element may comprise, or may be, a metal, for instance, aluminium or copper. The tribo-positive element may comprise, or may be, a metal oxide, for instance indium tin oxide (ITO).

When the transducer of the invention comprises a triboelectric generator which comprises a counter-electrode, said triboelectric generator often further comprises said tribo-positive element. The tribo-positive element may for instance be attached to the counter-electrode. Often, the tribo-positive element is a dielectric material. The tribo-positive element may comprise, or may be, a polymer, for instance nylon 6, nylon 66, nylon 11, silk, polytetrafluoroethylene (PTFE), polyfluoroalkoxy (PFA), cellulose, or a mixture of two or more thereof.

### Modes of the Triboelectric Generator

The relative movement between the tribo-negative element and the tribo-positive element sometimes comprises contacting the tribo-negative element with the tribo-positive element and separating the tribo-negative element from the tribo-positive element. This is known as “contact-separation mode”.

Alternatively, the relative movement between the tribo-negative element and the tribo-positive element may comprise sliding a surface of the tribo-negative element against a surface of the tribo-positive element. This is known as “sliding mode”. Typically, the sliding comprises lateral sliding (called the “lateral sliding mode”) or rotational sliding.

Often, in the contact-separation mode and in the sliding mode, the triboelectric generator further comprises a counter-electrode. The counter-electrode may itself be the tribo-positive element, or the tribo-positive element may be attached to the counter-electrode. The tribo-positive element may for instance be a dielectric material which is attached to the counter-electrode.

In other embodiments, the triboelectric generator does not comprise a counter electrode. Typically, in such embodiments, the triboelectric generator further comprises a reference electrode in electrical connection with the first electrode. This is known as “single electrode mode”.

When the triboelectric generator does not comprise a counter electrode, the tribo-positive element is typically not part of the triboelectric generator (i.e. not part of the transducer). In other words, the tribo-positive element may be an external element, rather than a component of the triboelectric generator. The tribo-positive element may for instance be the surface of a rubber glove worn by an operator, or the human skin of an operator. In some embodiments, therefore the tribo-positive element is not part of the triboelectric generator. The tribo-positive element may for instance be the surface of a rubber glove, for instance tribo-positive element may be nitrile rubber. The tribo-positive element may be human skin.

Typically, in the single electrode mode, i.e. in cases where the triboelectric generator does not comprise a counter electrode, the relative movement comprises contacting the tribo-negative element with the tribo-positive element and separating the tribo-negative element from the tribo-positive element.

In some embodiments of the triboelectric generator, the triboelectric generator further comprises a counter-electrode, the tribo-negative element is not in contact with the first electrode and is not in contact with the counter electrode, and the first electrode and the counter-electrode are the tribo-positive element. Furthermore, the relative movement between the tribo-negative element and the tribo-positive element comprises moving the tribo-negative element relative to the first electrode and the counter-electrode to arrange the tribo-negative element alternately (i) closer towards the first electrode and further away from the counter-electrode, and (ii) closer towards the counter-electrode and further away from the first electrode. This is known as the “free-standing mode”.

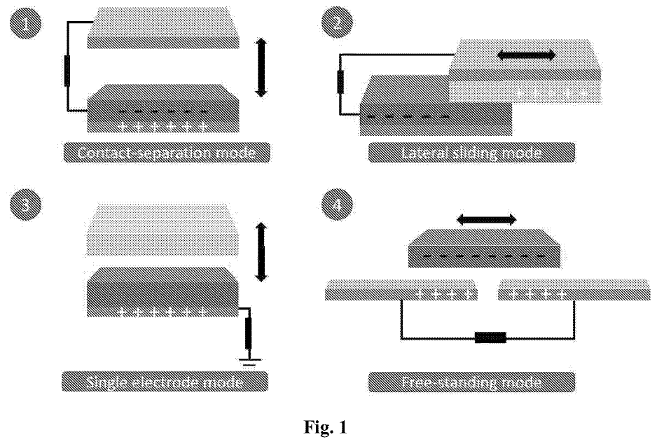

The contact-separation, lateral sliding, single electrode and free-standing modes are all shown schematically in FIG. 1, in which the relative movement between the tribo-negative element and the tribo-positive element in each of the modes is illustrated with an arrow.

A free-standing mode (or non-contact mode) device may preferably comprise a rotor (for example as displayed in FIG. 52). Such devices may be employed to generate electricity in devices which have a rotational movement, such as turbines, washing machines, tumble dryers, and combined washer/dryers.

Accordingly, the invention also provides a device comprising an electrical generator which comprises a transducer of the invention, wherein the transducer is a triboelectric generator, wherein the triboelectric generator comprises a tribo-negative element; and a first electrode, arranged to receive charge resulting from relative movement between the tribo-negative element and a tribo-positive element, wherein the tribo-negative element comprises said composite material, wherein the triboelectric generator further comprises a counter-electrode, wherein the tribo-negative element is not in contact with the first electrode and is not in contact with the counter electrode, and the first electrode and the counter-electrode are the tribo-positive element, wherein the relative movement comprises moving the tribo-negative element relative to the first electrode and the counter-electrode to arrange the tribo-negative element alternately (i) closer towards the first electrode and further away from the counter-electrode, and (ii) closer towards the counter-electrode and further away from the first electrode, wherein said moving comprises rotational movement, optionally wherein the device is a washing machine, tumble dryer, or combined washer dryer.

### Electronegative Substituents

The MOF employed in the various aspects of the present invention comprises a metal ion and an organic linker, wherein the organic linker comprises one or more electronegative substituents. Any one or more electronegative substituents can in principle be employed as the one or more electronegative substituents in the organic linker. Suitable electronegative substituents would be readily apparent to the skilled person in light of the present disclosure.

The one or more electronegative substituents may for instance be selected from fluoro, chloro, bromo, C₁₋₄ fluoroalkyl, C₁₋₄ chloroalkyl, C₁₋₄ bromoalkyl, C₁₋₄ fluoroalkoxy, C₁₋₄ chloroalkoxy, C₁₋₄ bromoalkoxy, a group of formula —OX, or a group of formula NXY, wherein X is H, F, Cl, or Br, and wherein Y is F, Cl, or Br.

The electronegative substituent is preferably not said group of formula —OX wherein X is H, F, Cl, or Br.

Thus, the electronegative substituent is preferably other than —OH, —OF, —OCl and —OBr.

Accordingly, often, the one or more electronegative substituents are selected from fluoro, chloro, bromo, C₁₋₄ fluoroalkyl, C₁₋₄ chloroalkyl, C₁₋₄ bromoalkyl, C₁₋₄ fluoroalkoxy, C₁₋₄ chloroalkoxy, C₁₋₄ bromoalkoxy, or a group of formula NXY, wherein X is H, F, Cl, or Br, and wherein Y is F, Cl, or Br. The one or more electronegative substituents are preferably fluoro, chloro, bromo, C₁₋₄ fluoroalkyl, C₁₋₄ chloroalkyl, or C₁₋₄ bromoalkyl, more preferably fluoro, chloro or bromo.

In this context, the prefixes (e.g., C₁₋₄, C₁₋₇, C₁₋₂₀, C₂₋₇, C₃₋₇, etc.) denote the number of carbon atoms, or range of number of carbon atoms. For example, the term “C₁₋₄-fluoroalkyl,” as used herein, pertains to a fluoroalkyl group having from 1 to 4 carbon atoms.

The C₁₋₄ fluoroalkyl and C₁₋₄ fluoroalkoxy may contain one or more fluoro groups, for example, one, two or three fluoro groups. Often the fluoroalkyl and fluoroalkoxy contain more than one fluoro group, for example two or three fluoro groups. Typically a C₁₋₄ fluoroalkyl and/or a C₁₋₄ fluoroalkoxy contains three fluoro groups. The C₁₋₄ fluoroalkyl may preferably be a C₁₋₂ fluoroalkyl, and is often a C₁ fluoroalkyl. Therefore, a C₁₋₄ fluoroalkyl is often a mono-, di-, or tri-fluoromethyl, and is typically a trifluoromethyl group.

The C₁₋₄ fluoroalkoxy may preferably be a C₁₋₂ fluoroalkoxy, and is often a C₁ fluoroalkoxy. Therefore, a C₁₋₄ fluoroalkoxy is often a mono-, di-, or tri-fluoromethoxy, and is typically a trifluoromethoxy group.

The C₁₋₄ chloroalkyl and C₁₋₄ chloroalkoxy may contain one or more chloro groups, for example, one, two or three chloro groups. Often the chloroalkyl and chloroalkoxy contain more than one chloro group, for example two or three chloro groups. Typically a C₁₋₄ chloroalkyl and/or a C₁₋₄ chloroalkoxy contains three chloro groups. The C₁₋₄ chloroalkyl may preferably be a C₁₋₂ chloroalkyl, and is often a C₁ chloroalkyl. Therefore, a C₁₋₄ chloroalkyl is often a mono-, di-, or tri-chloromethyl, and is typically a trichloromethyl group.

The C₁₋₄ chloroalkoxy may preferably be a C₁₋₂ chloroalkoxy, and is often a C₁ chloroalkoxy. Therefore, a C₁₋₄ chloroalkoxy is often a mono-, di-, or tri-chloromethoxy, and is typically a trichloromethoxy group.

The C₁₋₄ bromoalkyl and C₁₋₄ bromoalkoxy may contain one or more bromo groups, for example, one, two or three bromo groups. Often the bromoalkyl and bromoalkoxy contain more than one bromo group, for example two or three bromo groups.

Typically a C₁₋₄ bromoalkyl and/or a C₁₋₄ bromoalkoxy contains three bromo groups. The C₁₋₄ bromoalkyl may preferably be a C₁₋₂ bromoalkyl, and is often a C₁ bromoalkyl.

Therefore, a C₁₋₄ bromoalkyl is often a mono-, di-, or tri-bromomethyl, and is typically a tribromomethyl group.

The C₁₋₄ bromoalkoxy may preferably be a C₁₋₂ bromoalkoxy, and is often a C₁ bromoalkoxy. Therefore, a C₁₋₄ bromoalkoxy is often a mono-, di-, or tri-bromomethoxy, and is typically a tribromomethoxy group.

Typically the one or more electronegative substituents are selected from fluoro, chloro, bromo, trifluoromethyl, —NF₂, —NCl₂, —OF, —OCl, —OBr, —OH, and trifluoromethoxy.

Preferably, the one or more electronegative substituents are selected from fluoro, chloro, bromo, trifluoromethyl, —NF₂, —NCl₂ and trifluoromethoxy. More preferably, the one or more electronegative substituents are selected from fluoro, chloro, bromo, trifluoromethyl and trifluoromethoxy. The one or more electronegative substituents may for instance be selected from fluoro, chloro and bromo, trifluoromethyl and trifluoromethoxy. The one or more electronegative substituents may for instance be selected from fluoro, chloro and bromo.

The one or more electronegative substituents may be selected from fluoro or chloro. Often the one or more electronegative substituents are chloro.

### Organic Linker

The organic linker may comprise only one electronegative substituent. Alternatively, the organic linker may comprise more than one electronegative substituent, for instance, two or three electronegative substituents. When the organic linker comprises more than one electronegative substituents, the electronegative substituents may be the same or different, and optionally they may be independently selected from any of the electronegative substituents defined above. Often, the one or more electronegative substituents are the same. They may for instance be any one of the electronegative substituents defined above. For example, they may all be chloro. Alternatively, they may all be bromo.

The term “organic linker” as used herein indicates an organic molecule comprising two or more coordination sites suitable for coordinating to metal ions. Thus, an organic linker typically comprises two or more functional groups capable of coordinating to metal ions.

The organic linker may be an imidazole-based linker or a carboxylate ion linker. Typically, the organic linker is an imidazole-based linker, for instance an imidazolate linker or an imidazole linker. It is often an imidazolate linker.

When the organic linker is an imidazole-based linker, the imidazole-based linker may be an imidazolate linker of formula (I) or an imidazole linker of formula (II):

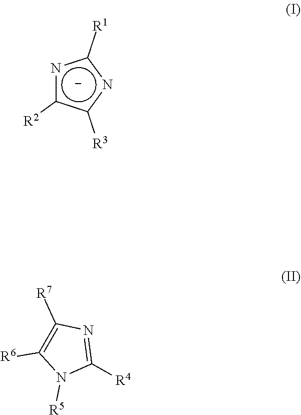

In formula (I), R¹, R² and R³ are each independently selected from an electronegative substituent, hydrogen, unsubstituted or substituted C₁₋₁₀ alkyl, unsubstituted or substituted C₂₋₁₀ alkenyl, unsubstituted or substituted C₂₋₁₀ alkynyl and cyano; provided that R² and R³ may be joined so as to form a substituted or unsubstituted ring. R² and R³ may for instance be joined to form a 5 or 6-membered ring. The ring may optionally comprise 1, 2 or 3 heteroatoms selected from O, N and S. Also, any one of R¹, R² and R³ may be an unsubstituted or substituted hydrocarbon linker (for instance an unsubstituted or substituted C₁₋₁₀ alkylene group) bonded to a further substituted or unsubstituted imidazolate ring or to a further substituted or unsubstituted imidazole ring.

In formula (I), one or more of R¹, R² and R³ comprise said one or more electronegative substituents. Preferably one or more of R¹, R² and R³ are said one or more electronegative substituents. Each electronegative substituent may be independently selected from an electronegative substituent as defined above and may, for instance, be selected from chloro, fluoro and bromo. Thus, for instance, R¹, R² and R³ may each be independently selected from fluoro, chloro, bromo, hydrogen, unsubstituted or substituted C₁₋₁₀ alkyl, unsubstituted or substituted C₂₋₁₀ alkenyl, unsubstituted or substituted C₂₋₁₀ alkynyl and cyano, provided that one or more of R¹, R² and R³ is an electronegative substituent selected from fluoro, chloro and bromo.

In some preferred embodiments of formula (I), R¹ is an electronegative substituent, and may, for instance be an electronegative substituent as further defined anywhere herein. Often, R¹ is selected from the electronegative substituents fluoro, chloro and bromo, and is typically chloro or bromo.

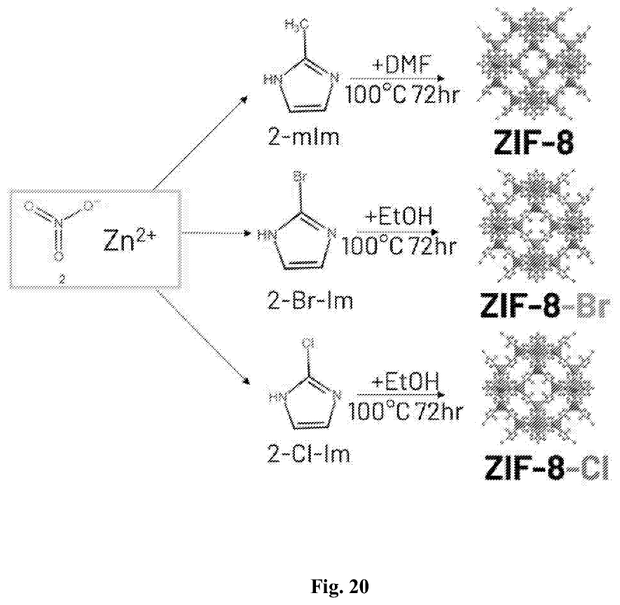

In the abovementioned preferred embodiments in which R¹ is an electronegative substituent, R² and R³ may be H. Therefore, often, R¹ is an electronegative substituent and R² and R³ are H. Typically R¹ is selected from fluoro, chloro and bromo, typically chloro or bromo, and R² and R³ are H. Such organic linkers may form part of a modified ZIF-8, for example ZIF-8-Br or ZIF-8-Cl as displayed in FIG. 20. In unmodified ZIF-8, which is denoted “ZIF-8” in FIG. 20, R¹ is methyl and R² and R³ are H.

In formula (II), R⁴, R⁵, R⁶ and R⁷ are each independently selected from an electronegative substituent, hydrogen, unsubstituted or substituted C₁₋₁₀ alkyl, unsubstituted or substituted C₂₋₁₀ alkenyl, unsubstituted or substituted C₂₋₁₀ alkynyl and cyano; provided that R⁶ and R⁷ may be joined so as to form a substituted or unsubstituted ring. R⁶ and R⁷ may for instance be joined to form a 5 or 6-membered ring. The ring may optionally comprise 1, 2 or 3 heteroatoms selected from O, N and S. Also, any one of R⁴, R⁵, R⁶ and R⁷ may be an unsubstituted or substituted hydrocarbon linker (for instance an unsubstituted or substituted C₁₋₁₀ alkylene group) bonded to a further substituted or unsubstituted imidazolate ring or to a further substituted or unsubstituted imidazole ring. In formula (II), one or more of R⁴, R⁵, R⁶ and R⁷ comprise said one or more electronegative substituents. Preferably, one or more of R⁴, R⁵, R⁶ and R⁷ are said one or more electronegative substituents. Each electronegative substituent may be independently selected from an electronegative substituent as defined above and may, for instance, be selected from chloro, fluoro and bromo. Thus, for instance, R⁴, R⁵, R⁶ and R⁷ may each be independently selected from fluoro, chloro, bromo, hydrogen, unsubstituted or substituted C₁₋₁₀ alkyl, unsubstituted or substituted C₂₋₁₀ alkenyl, unsubstituted or substituted C₂₋₁₀ unsubstituted or substituted alkynyl and cyano, provided that one or more of R⁴, R⁵, R⁶ and R⁷ is an electronegative substituent selected from fluoro, chloro and bromo.

In some preferred embodiments of formula (II), R⁴ is an electronegative substituent, and may, for instance be an electronegative substituent as further defined anywhere herein. Often, R⁴ is selected from the electronegative substituents fluoro, chloro and bromo, and is typically chloro or bromo. In the aforementioned preferred embodiments in which R⁴ is an electronegative substituent, R⁶ and R⁷ may be H. R⁵ may be H. Therefore, often, R⁴ is an electronegative substituent and R⁶ and R⁷ are H. R⁵ is also often H. Typically R⁴ is selected from fluoro, chloro and bromo, typically chloro or bromo, and R⁵, R⁶ and R⁷ are H. Such organic linkers are shown in FIG. 20, for the synthesis of the modified ZIF-8 MOFs denoted ZIF-8-Br and ZIF-8-Cl.

The term “alkyl”, as used herein, refers to a linear or branched chain saturated hydrocarbon radical. An alkyl group may be a C₁₋₂₀ alkyl group, a C₁₋₁₄ alkyl group, a C₁₋₁₀ alkyl group, a C₁₋₆ alkyl group or a C₁₋₄ alkyl group. Examples of a C₁₋₁₀ alkyl group are methyl, ethyl, propyl, butyl, pentyl, hexyl, heptyl, octyl, nonyl or decyl. Examples of C₁₋₆ alkyl groups are methyl, ethyl, propyl, butyl, pentyl or hexyl. Examples of C₁₋₄ alkyl groups are methyl, ethyl, i-propyl, n-propyl, t-butyl, s-butyl or n-butyl. If the term “alkyl” is used without a prefix specifying the number of carbons, it typically has from 1 to 6 carbons (and this also applies to any other organic group referred to herein). An alkyl group may be unsubstituted or substituted. Typically a substituted alkyl group carries 1, 2 or 3 substituents, for instance 1 or 2.

The term “alkenyl”, as used herein, refers to a linear or branched chain hydrocarbon radical containing one or more double bonds. A “Cₙ₋ₘ alkenyl” refers to an alkenyl having from n to m carbon atoms. Thus, an alkenyl group may be a C₂₋₁₈ alkenyl group, a C₂₋₁₄ alkenyl group, a C₂₋₁₀ alkenyl group, a C₂₋₆ alkenyl group or a C₂₄ alkenyl group. Examples of a C₂₋₁₀ alkenyl group are ethenyl (vinyl), propenyl, butenyl, pentenyl, hexenyl, heptenyl, octenyl, nonenyl or decenyl. Examples of C₂₋₆ alkenyl groups are ethenyl, propenyl, butenyl, pentenyl or hexenyl. Examples of C₂₄ alkenyl groups are ethenyl, i-propenyl, n-propenyl, s-butenyl or n-butenyl. Alkenyl groups typically comprise one or two double bonds. An alkenyl group may be substituted or unsubstituted. Typically a substituted alkenyl group carries 1, 2 or 3 substituents, for instance 1 or 2.

The term “alkynyl”, as used herein, refers to a linear or branched chain hydrocarbon radical containing one or more triple bonds. A “Cₙ₋ₘ alkynyl” refers to an alkynyl having from n to m carbon atoms. Thus, an alkynyl group may be a C₂₋₁₈ alkynyl group, a C₂₋₁₄ alkynyl group, a C₂₋₁₀ alkynyl group, a C₂₋₆ alkynyl group or a C₂₋₄ alkynyl group. Examples of a C₂₋₁₀ alkynyl group are ethynyl, propynyl, butynyl, pentynyl, hexynyl, heptynyl, octynyl, nonynyl or decynyl. Examples of C₁₋₆ alkynyl groups are ethynyl, propynyl, butynyl, pentynyl or hexynyl. Alkynyl groups typically comprise one or two triple bonds. An alkynyl group may be substituted or unsubstituted. Typically a substituted alkynyl group carries 1, 2 or 3 substituents, for instance 1 or 2.

The term “alkylene group” as used herein, refers to a substituted or unsubstituted bidentate moiety obtained by removing two hydrogen atoms, either both from the same carbon atom, or one from each of two different carbon atoms, of a hydrocarbon compound having from 1 to 20 carbon atoms (unless otherwise specified), which may be aliphatic or alicyclic, and which may be saturated, partially unsaturated, or fully unsaturated. Thus, the term “alkylene” includes the sub-classes alkenylene, alkynylene, cycloalkylene, etc. Typically it is C₁₋₁₀ alkylene, for instance C₁₋₆ alkylene. Typically it is C₁₋₄ alkylene, for example methylene, ethylene, i-propylene, n-propylene, t-butylene, s-butylene or n-butylene. It may also be pentylene, hexylene, heptylene, octylene and the various branched chain isomers thereof. An alkylene group may be substituted or unsubstituted. Typically a substituted alkylene group carries 1, 2 or 3 substituents, for instance 1 or 2.

The term “substituted”, as used herein, in the context of substituted organic compounds and groups, refers to an organic compound or group (e.g. an alkyl group, an alkenyl group, an alkynyl group, or an alkylene group) which bears one or more substituents selected from C₁₋₁₀ alkyl, C₃₋₁₀ cycloalkyl, C₃₋₇ heterocyclyl, aryl, heteroaryl, cyano, amino, nitro, C₂₋₁₀ alkenyl, C₂₋₁₀ alkynyl, C₁₋₁₀ alkylamino, di(C₁₋₁₀)alkylamino, arylamino, diarylamino, aryl(C₁₋₁₀)alkylamino, amido, acylamido, hydroxy, oxo, halo, carboxy, ester, acyl, acyloxy, C₁₋₁₀ alkoxy, aryloxy, halo(C₁₋₁₀)alkyl, sulfonic acid, thiol, C₁₋₁₀ alkylthio, arylthio, sulfonyl, phosphoric acid, phosphate ester, phosphonic acid, phosphonate ester and SO₃⁻. Typically, the one or more substituents are selected from cyano, amino, nitro, amido, acylamido, hydroxy, oxo, halo, carboxy, ester, acyl, acyloxy, sulfonic acid, thiol, sulfonyl, phosphoric acid, phosphate ester, phosphonic acid, phosphonate ester and SO₃⁻. When a compound or group is substituted, it typically bears 1, 2, 3 or 4 substituents. For instance, a substituted compound or group may have 1, 2 or 3 substituents, or for example 1 or 2 substituents.

Typically, the organic linker is an imidazolate linker of formula (I) wherein R² and R³ are the one or more electronegative substituents (which may be as further defined anywhere herein). Typically, R¹ is H and R² and R³ are selected from chloro and fluoro.

Typically, the organic linker is an imidazolate linker of formula (I) wherein R¹ is the one or more electronegative substituents (which may be as further defined anywhere herein). Typically, R¹ is bromo or chloro and R² and R³ are H, preferably wherein R¹ is chloro.

Often, the organic linker is an imidazole linker of formula (II), wherein R⁶ and R⁷ are the one or more electronegative substituents (which may be as further defined anywhere herein). Often R⁴ and R⁵ are both H, and R⁶ and R⁷ are selected from chloro and fluoro. The organic linker may be an imidazole linker of formula (II) wherein R⁴ is the one or more electronegative substituents (which may be as further defined anywhere herein). Typically, R⁴ is bromo or chloro and R⁶ and R⁷ are H, preferably wherein R⁴ is chloro. R⁵ may be H.

The organic linker may for instance be an imidazolate linker of formula (I) wherein R¹ is H and R² and R³ are both chlorine (4,5-dichloroimidazolate). The organic linker may also be linker of formula (I) wherein R¹ is bromo or chloro and R² and R³ are H (2-bromoimidazolate or 2-chloroimidazolate). The organic linker may alternatively be an imidazole linker of formula (II) wherein R⁴ and R⁵ are both H and R⁶ and R⁷ are both chlorine (4,5-dichloroimidazole). The organic linker may also be linker of formula (II) wherein R⁴ is bromo or chloro, and R⁵, R⁶ and R⁷ are all H (2-bromo-1H-imidazole or 2-chloro-1H-imidazole).

In preferred embodiments, the organic linker is 4,5-dichloroimidazolate.

In preferred embodiments, the organic linker is 2-bromoimidazolate.

In preferred embodiments, the organic linker is 2-chloroimidazolate.

### Metal Ion

The MOF comprises a metal ion. The MOF may comprise only one kind of metal ion or it may comprise two or more different kinds of metal ions. The kinds of metal ions may differ by charge and/or element. Typically, the MOF comprises only one kind of metal ion or only two different kinds of metal ions. Usually the MOF comprises only one kind of metal ion.

The or each metal ion may be selected from metal ions of groups 9, 10, 11, 12 and 14 of the periodic table. Thus, the or each metal ion may be selected from a cobalt (Co) ion, a rhodium (Rh) ion, an iridium (Ir) ion, a nickel (Ni) ion, a palladium (Pd) ion, a platinum (Pt) ion, a copper (Cu) ion, a silver (Ag) ion, a gold (Au) ion, a zinc (Zn) ion, a cadmium (Cd) ion, a mercury (Hg) ion and a lead (Pb) ion. Typically, the metal ion is an Ag, Au, Cu, Zn, Co, Cd, Ir, Pt, Pd or Pb ion. Often, the metal ion is selected from Ag, Au, Cu, Zn, Co, Cd, Ir, Pt and Pd ions. In some preferred embodiments, the metal ion is a Zn ion, for instance Zn²⁺.

The MOF employed in the present invention may have a particle size of from 0.2 μm to 1.8 μm, for instance from 0.5 μm to 1.5 μm, for example about 1 μm.

The MOFs employed in the present invention may be prepared by treating (a) a metal precursor compound (for instance a metal salt) which comprises the metal that is to become the metal ion in the MOF, with (b) an organic compound which is the organic linker for the MOF or which is a suitable precursor which forms the organic linker upon reaction with the metal. The treatment of (a) with (b) may be performed in the presence or absence of a solvent, and may be performed at ambient temperature or in the presence of heat. For instance, one MOF as described herein may be produced by treating a solution of the metal precursor compound zinc acetate in a polar protic solvent with a solution of the organic compound 4,5-dichloroimidazole in a polar protic solvent, under ambient conditions, and then recovering the resulting precipitate. Another MOF as described herein may be produced by heating a mixture of the metal precursor compound zinc oxide and the organic compound 4,5-dichloroimidazole at a temperature of at least 100° C. in the absence of a solvent.

Another MOF as described herein may be produced by heating a mixture of a metal precursor compound (e.g. a zinc precursor compound, for instance zinc nitrate) and the organic compound 2-bromo-1H-imidazole or 2-chloro-1H-imidazole, typically at a temperature of around 100° C. or greater than 100° C., in the presence of a solvent, such as a polar protic solvent, which may optionally be an organic solvent and is typically ethanol.

### Zeolitic Imidazolate Framework (ZIF)

One subclass of MOF is a zeolitic imidazolate framework (ZIF). ZIFs are topologically isomorphic with zeolites. ZIFs are typically composed of tetrahedrally-coordinated transition metal ions connected by imidazolate linkers.

The metal organic framework employed in the present invention may be a zeolitic imidazolate framework (ZIF).

Typically, in the MOF employed in the present invention, the metal ion is a zinc ion (for instance Zn²⁺) and the organic linker is 4,5-dichloroimidazolate. Also typically, in the MOF employed in the present invention, the metal ion is a zinc ion (for instance Zn²⁺) and the organic linker is 2-bromoimidazolate or 2-chloroimidazolate, preferably 2-chloroimidazolate.

The metal organic framework employed in the present invention may be one which is obtainable by (i) treating a solution of zinc acetate in a polar protic solvent with a solution of 4,5-dichloroimidazole in a polar protic solvent, under ambient conditions, and (ii) recovering the resulting precipitate. Typically the or each polar protic solvent is an alcohol, for instance methanol. Thus, the MOF may be obtainable by (i) treating a solution of zinc acetate in methanol with a solution of 4,5-dichloroimidazole in methanol, and (ii) recovering the resulting precipitate. Often the molar ratio of the 4,5-dichloroimidazole to the zinc acetate is from 6:1 to 2:1. In some preferred embodiments the molar ratio of the 4,5-dichloroimidazole to the zinc acetate is about 4:1. The MOF known as ZIF-71 is obtainable by such a process.

The metal organic framework employed in the present invention may be ZIF-71.

Often the MOF employed in the present invention is porous. Such a MOF is preferably nanoporous. Thus, usually, the MOF comprises nanocrystals which are themselves porous. The pore diameter may be from 16.0 Å to 17.0 Å, for instance from 16.5 Å to 16.8 Å.

The porosity of the MOF is often characterised by the BET surface area, which as the skilled person will be aware is measured by the volume of nitrogen gas adsorbed onto the material. Typically, the MOF has a BET surface area of from 900 m²g⁻¹ to 1100 m²g⁻¹, for instance about 1015 m²g⁻¹.

Often, the MOF employed in the present invention has a density of less than 1.50 g cm⁻³, for instance a density of from 1.00 g cm⁻³ to 1.30 g cm⁻³.

The MOF employed in the present invention may comprise nanocrystals having a rhombic dodecahedron shape.

The MOF employed in the present invention may have RHO topology.

The MOF employed in the present invention may be a MOF which is characterised by a powder X-ray diffraction pattern which comprises peaks at 2θ of 4.4°±0.2° and 7.6°±0.2°, measured using X-rays from a Cu Kα source having a wavelength of 1.541 Å.

The MOF employed in the present invention may for instance be a MOF which is characterised by a Fourier transform infrared spectrum which comprises peaks at 1466 cm⁻¹±10 cm⁻¹ and 1202 cm⁻¹±10 cm⁻¹, and which does not comprise peaks at 1414 cm⁻¹±10 cm⁻¹ and 1350 cm⁻¹±10 cm⁻¹.

The MOF employed in the present invention may have a void space of from 40% to 60% of the unit cell volume, for instance about 50% of the unit cell volume. The void space is preferably calculated using contact surface with a probe radius of 1.2 Å.

The MOF employed in the present invention may have a pore diameter of from 16.0 Å to 17.0 Å, for instance from 16.5 Å to 16.8 Å.

Typically, therefore, the MOF employed in the present invention:
is porous, preferably nanoporous, and more preferably comprises nanocrystals which are themselves porous; and/or
has a density of less than 1.50 g cm⁻³, and preferably of from 1.00 g cm⁻³ to 1.30 g cm⁻³; and/or
comprises nanocrystals having a rhombic dodecahedron shape; and/or
has RHO topology; and/or
is characterised by a powder X-ray diffraction pattern which comprises peaks at 2θ of 4.4°±0.2° and 7.6°±0.2°, measured using X-rays from a Cu Kα source having a wavelength of 1.541 Å; and/or
is characterised by a Fourier transform infrared spectrum which comprises peaks at 1466 cm⁻¹±10 cm⁻¹ and 1202 cm⁻¹±10 cm⁻¹ but does not comprise peaks at 1414 cm⁻¹±10 cm⁻¹ and 1350 cm⁻¹±10 cm⁻¹; and/or
has a BET surface area of from 900 m²g⁻¹ to 1100 m²g⁻¹, preferably about 1015 m²g⁻¹; and/or
has a void space of from 40% to 60% of the unit cell volume, for instance about 50% of the unit cell volume, wherein void space is preferably calculated using contact surface with a probe radius of 1.2 Å; and/or
has a pore diameter of from 16.0 Å to 17.0 Å, for instance from 16.5 Å to 16.8 Å.

In one embodiment, the MOF employed in the present invention has all of the features listed in the preceding paragraph. Such features are characteristic of ZIF-71.

Alternatively, the metal organic framework employed in the present invention may be obtainable by heating a mixture of zinc oxide and 4,5-dichloroimidazole at a temperature of at least 100° C. Typically the mixture is heated at that temperature in the absence of a solvent. The temperature may be from about 120° C. to about 180° C. and is preferably about 150° C. Often the molar ratio of the 4,5-dichloroimidazole to the zinc oxide is from 5:1 to 1:1 and it is preferably about 3:1. The MOF known as ZIF-72 is obtainable by such a process.

The metal organic framework employed in the present invention may be ZIF-72.

Often the MOF employed in the present invention is non-porous.

The MOF employed in the present invention may have a density of equal to or greater than 1.50 g cm⁻³. The density of the MOF may for instance be from 1.60 g cm⁻³ to 1.90 g cm⁻³.

The MOF employed in the present invention may have LCS topology.

The MOF employed in the present invention may for instance be characterised by a powder X-ray diffraction pattern which comprises peaks at 2θ of 12.7°±0.2° and 16.9° 0.2°, measured using X-rays from a Cu Kα source having a wavelength of 1.541 Å.

The MOF employed in the present invention may for instance be characterised by a Fourier transform infrared spectrum which comprises peaks at 1466 cm⁻¹±10 cm⁻¹, 1414 cm⁻¹±10 cm⁻¹, 1350 cm⁻¹±10 cm⁻¹ and 1202 cm⁻¹±10 cm⁻¹.

The MOF employed in the present invention may have a void space of from 1% to 10% of the unit cell volume, for instance about 5%. The void space may be determined using contact surface with a probe radius of 1.2 Å.

Often, therefore, the MOF employed in the present invention:
has a density of equal to or greater than 1.50 g cm⁻³, and preferably of from 1.60 g cm⁻³ to 1.90 g cm⁻³; and/or
has LCS topology; and/or
is characterised by a powder X-ray diffraction pattern which comprises peaks at 2θ of 12.7°±0.2° and 16.9°±0.2°, measured using X-rays from a Cu Kα source having a wavelength of 1.541 Å; and/or
is characterised by a Fourier transform infrared spectrum which comprises peaks at 1466 cm⁻¹±10 cm⁻¹, 1414 cm⁻¹±10 cm⁻¹, 1350 cm⁻¹±10 cm⁻¹ and 1202 cm⁻¹±10 cm⁻¹; and/or
has a void space of from 1% to 10% of the unit cell volume, for instance about 5%.

In one embodiment, the MOF employed in the present invention has all of the features listed in the preceding paragraph. Such features are characteristic of ZIF-72.

The MOF employed in the present invention may also be non-porous.

The metal organic framework employed in the present invention may be one which is obtainable by (i) treating zinc nitrate with 2-bromo-1H-imidazole or 2-chloro-1H-imidazole in a polar protic solvent, at around 100° C., and (ii) recovering the resulting precipitate. Typically the polar protic solvent is an alcohol, for instance ethanol. Thus, the MOF may be obtainable by (i) treating zinc nitrate with 2-bromo-1H-imidazole or 2-chloro-1H-imidazole in ethanol, and (ii) recovering the resulting precipitate. Often the molar ratio of the 2-bromo-1H-imidazole or 2-chloro-1H-imidazole to the zinc nitrate is from 6:1 to 1:1. In some preferred embodiments the molar ratio of the 2-bromo-1H-imidazole or 2-chloro-1H-imidazole to the zinc nitrate is about 2:1. The MOF known as ZIF-8-Br (if 2-bromo-1H-imidazole used) or ZIF-8-Cl (if 2-chloro-1H-imidazole used) is obtainable by such a process. Such MOFs are displayed in FIG. 20.

### Composite Material

The polymer matrix of the composite material employed in the present invention typically comprises a hydrophobic polymer, i.e. a polymer which has limited solubility in water and other polar solvents. Non-limiting examples of hydrophobic polymers which may be employed include acrylics, epoxies, polyethylenes, polystyrenes, polyvinylchlorides, polyesters, polyurethanes, polyvinylidene fluorides, polyimides and polysiloxanes.

Typically, the polymer matrix comprises a polysiloxane, a polyvinylidene fluoride (PVDF), a polystyrene (PS) or a polyimide (PI). Often, the polymer matrix comprises a polysiloxane. The polysiloxane may for instance be polydimethylsiloxane (PDMS). Often the polymer matrix comprises polyvinylidene fluoride (PVDF). Typically the polymer matrix comprises PDMS or PVDF.

The MOF is dispersed in the polymer matrix. Typically, particles of the MOF are dispersed in the polymer matrix. Particles of the MOF may be dispersed throughout the polymer matrix, for instance they may be evenly dispersed throughout the polymer matrix.

A particle may be spherical or non-spherical. Non-spherical particles may for instance be plate-shaped, needle-shaped or tubular. The term “particle size” as used herein means the diameter of the particle if the particle is spherical or, if the particle is non-spherical, the volume-based particle size. The volume-based particle size is the diameter of the sphere that has the same volume as the non-spherical particle in question. Particle size may be measured using methods well known in the art, including, for instance, dynamic light scattering and transmission electron microscopy (TEM) image analysis.

The particles of the MOF that are dispersed in the polymer matrix typically have a mean particle size of from 0.2 μm to 1.8 μm. Usually, the MOF particles have a mean particle size of from 0.5 μm to 1.5 μm. Often the mean particle size is about 1 μm.

The composite material may be produced by mixing as-synthesised MOF particles with a solution of the polymer, or with a solution of an elastomer precursor to the polymer and a curing agent, and dispersing the MOF evenly in the polymer using a blender.

Typically, the MOF/polymer mixture is then disposed on a substrate, e.g. by doctor blading or spin coating, to obtain a film with uniform thickness. The cast film may then be cured if necessary and the residual solvent removed (e.g. by heating at an elevated temperature in a vacuum oven) and the film may then be peeled off from the substrate. The prepared MOF polymer composite may then be cut to size as desired for subsequent use. The average thickness of the MOF polymer composite may for instance be from 100 μm to 500 μm, for instance about 350 μm.

The amount of the metal organic framework in the composite material is typically less than or equal to 5 wt % based on the total weight of the composite material. For instance, the amount of the MOF may be about 4 wt %, about 3 wt %, about 2 wt % or about 1 wt %, based on the total weight of the composite material. Often the amount of the MOF in the composite material is less than or equal to 3 wt %, or for instance less than or equal to 2 wt %, or less than or equal to 1 wt %, based on the total weight of the composite material. The amount of the MOF in the composite material may for instance be from 1.5 wt % to 2.5 wt % based on the total weight of the composite material, for instance from 1.8 wt % to 2.2 wt %, or for instance about 2 wt %. The amount of the MOF in the composite material may alternatively for instance be from 0.5 wt % to 1.5 wt % based on the total weight of the composite material, for instance from 0.8 wt % to 1.2 wt %, or for instance about 1 wt %.

In some embodiments, (a) the polymer matrix comprises PDMS, and (b) the metal organic framework: (i) is ZIF-71, or (ii) is obtainable by treating a solution of zinc acetate in a polar protic solvent with a solution of 4,5-dichloroimidazole in a polar protic solvent, under ambient conditions, and recovering the resulting precipitate, or (iii) meets at least one of the following criteria, preferably at least three of the following criteria, more preferably all of the following criteria:
the MOF is porous, preferably nanoporous, and more preferably comprises nanocrystals which are themselves porous;
the MOF has a density of less than 1.50 g cm⁻³, and preferably of from 1.00 g cm⁻³ to 1.30 g cm⁻³;
the MOF comprises nanocrystals having a rhombic dodecahedron shape;
the MOF has RHO topology;
the MOF is characterised by a powder X-ray diffraction pattern which comprises peaks at 2θ of 4.4°±0.2° and 7.6°±0.2°, measured using X-rays from a Cu Kα source having a wavelength of 1.541 Å;
the MOF is characterised by a Fourier transform infrared spectrum which comprises peaks at 1466 cm⁻¹±10 cm⁻¹ and 1202 cm⁻¹±10 cm⁻¹ but does not comprise peaks at 1414 cm⁻¹±10 cm⁻¹ and 1350 cm⁻¹±10 cm⁻¹;
the MOF has a BET surface area of from 900 m²g⁻¹ to 1100 m²g⁻¹, preferably about 1015 m²g⁻¹;
the MOF has a void space of from 40% to 60% of the unit cell volume, for instance about 50% of the unit cell volume, wherein void space is preferably calculated using contact surface with a probe radius of 1.2 Å; and
the MOF has a pore diameter of from 16.0 Å to 17.0 Å, for instance from 16.5 Å to 16.8 Å.

In such embodiments, the amount of the metal organic framework in the composite material is often from 1.5 wt % to 2.5 wt % based on the total weight of the composite material. Typically the amount of metal organic framework in the composite material is from 1.8 wt % to 2.2 wt % based on the total weight of the composite material. Often, the amount of metal organic framework in the composite material is about 2 wt % based on the total weight of the composite material.

In other embodiments, (a) the polymer matrix comprises PDMS, and (b) the metal organic framework (i) is ZIF-72, or (ii) is obtainable by heating a mixture of zinc oxide and 4,5-dichloroimidazole at a temperature of at least 100° C., preferably in the absence of a solvent, or (iii) meets at least one of the following criteria, preferably at least three of the following criteria, more preferably all of the following criteria:
the MOF is non-porous;
the MOF has a density of equal to or greater than 1.50 g cm⁻³, and preferably of from 1.60 g cm⁻³ to 1.90 g cm⁻³;
the MOF has LCS topology;
the MOF is characterised by a powder X-ray diffraction pattern which comprises peaks at 2θ of 12.7°±0.2° and 16.9°±0.2°, measured using X-rays from a Cu Kα source having a wavelength of 1.541 Å;
the MOF is characterised by a Fourier transform infrared spectrum which comprises peaks at 1466 cm⁻¹±10 cm⁻¹, 1414 cm⁻¹±10 cm⁻¹, 1350 cm⁻¹±10 cm⁻¹ and 1202 cm⁻¹±10 cm⁻¹; and
has a void space of from 1% to 10% of the unit cell volume, for instance about 5%, wherein void space is preferably calculated using contact surface with a probe radius of 1.2 Å.

In such embodiments, the amount of the metal organic framework in the composite material is from 0.5 wt % to 1.5 wt % based on the total weight of the composite material. Often, the amount of the metal organic framework in the composite material is from 0.8 wt % to 1.2 wt % based on the total weight of the composite material. For instance, the amount of the metal organic framework in the composite material is typically about 1 wt % based on the total weight of the composite material.

In some embodiments, (a) the polymer matrix comprises PVDF, and (b) the metal organic framework: (i) is ZIF-8-Br or ZIF-8-Cl, or (ii) is obtainable by treating a solution of zinc nitrate in a polar protic solvent with a solution of 2-bromo-1H-imidazole or 2-chloro-1H-imidazole in a polar protic solvent, heating, typically at a temperature of around 100° C. or at a temperature greater than 100° C., and recovering the resulting precipitate.

In such embodiments, the amount of the metal organic framework in the composite material is often from 0.5 wt % to 15 wt %, for instance from 1 wt % to 10 wt %, based on the total weight of the composite material. Often, the amount of the metal organic framework in the composite material is from 3 wt % to 7 wt % based on the total weight of the composite material. For instance, the amount of the metal organic framework in the composite material is typically about 5 wt % based on the total weight of the composite material.

In such embodiments, the composite material is often a fibre, typically an electrospun fibre.

In such embodiments, the composite material may comprise fibres which comprise said polymer matrix and, dispersed in the matrix, said metal organic framework. The fibres may be electrospun fibres (i.e. they may have been produced by electrospinning).

### Composite Material

The invention also provides a composite material which comprises a polymer matrix and, dispersed in the matrix, a metal organic framework, wherein the metal organic framework comprises a metal ion and an organic linker, wherein the organic linker comprises one or more electronegative substituents.

The composite material of the invention may be as further defined anywhere herein, for instance as further defined anywhere hereinbefore. For instance, the polymer matrix and the metal organic framework may be as further defined anywhere herein.

The composite material of the invention may be a composite fibre. Such a composite fibre may be prepared by electrospinning.

The composite material may comprise fibres which comprise said polymer matrix and, dispersed in the matrix, said metal organic framework. The fibres may be electrospun fibres (i.e. they may have been produced by electrospinning).

Often when the composite material is a composite fibre, or comprise fibres, the matrix comprises PVDF. For example a composite fibre of PVDF and ZIF-8-X, wherein X is Cl or Br may be prepared. Such a fibre may for instance be prepared by electrospinning.

Products Comprising the Transducer and/or Composite Material of the Invention

The invention further provides an electrical generator which comprises a transducer of the invention. The transducer may be a triboelectric generator, which may be as further defined anywhere herein. The electrical generator is typically a generator of electrical power. It may be used to power other applications. The electrical power that is generated may for instance be used to power an electronic device, or to charge an electronic device. Alternatively the generated electrical power may be stored for later use.

The invention also provides products comprising an electrical generator of the invention. The product may be an electronic device. The electronic device may for instance be a wearable electronic device, microelectronics, a humidity thermometer, a digital timer, or a calculator; a charging device, for instance a phone charger; a capacitor; a light emitting diode; or a transmitter, for instance a Bluetooth transmitter. The product may for instance be a humidity thermometer, a digital timer, a calculator, and an LED.

A wearable electronic device as used herein is a device that can be worn on any part of the human or animal body, either by being worn as standalone device, or being attached to another item of clothing. For example, a wearable electronic device could be worn on the wrist, ankle, arm, hear, around the waist, around the head, around or on the chest, around the neck, or in the ear. A wearable electronic device may also penetrate the skin, for example it may have a sensing component which penetrates the skin. A wearable electronic device could also be attached to an item of clothing, for example a belt, a trouser, a skirt, a shoe, a sock, a shirt, a jumper, or a dress. A wearable electronic device could therefore be a movement sensor, (e.g. a pedometer), a charging device, a speaker (i.e. headphones or earphones), or a sensor or monitor for a bodily function (e.g. an oxygen sensor, or a heart rate and/or pulse monitor, a glucose sensor).

A charging device may be a charging device for any appropriate electronic device, for example a wearable electronic device, microelectronics, a humidity thermometer, a digital timer, or a calculator; a capacitor; a light emitting diode; a transmitter, for instance a Bluetooth transmitter; a mobile device, such as a mobile phone.

A transmitter may be a transmitter of any appropriate electronic signal, such as sound waves, gamma waves, X-rays, ultraviolet waves, visible light, infrared waves, microwaves and radio waves. For example, a transmitter may be a communication device, or a speaker or headphones or earphones.

The invention also provides an electrical generator which comprises a transducer of the invention, wherein the transducer is a triboelectric generator. The triboelectric generator comprises a tribo-negative element; and a first electrode, arranged to receive charge resulting from relative movement between the tribo-negative element and a tribo-positive element, wherein the tribo-negative element comprises a composite material as defined herein, and wherein the relative movement comprises sliding a surface of the tribo-negative element against a surface of the tribo-positive element, wherein the sliding comprises rotational sliding, and wherein the relative movement is caused by wind and/or wave. Typically, in this embodiment, the counter-electrode is said tribo-positive element. Alternatively, the triboelectric generator may further comprise said tribo-positive element, and the tribo-positive element is attached to the counter-electrode.

The relative movement may be caused by wind. Wind as referred to herein may be wind caused by the weather or wind generated by movement of an object, for example a passing vehicle. The wind may for instance be generated by a passing train. An example of a triboelectric generator where the relative movement comprises wind-powered rotational sliding of a surface of a tribo-negative element against a surface of a tribo-positive element is described in Zhang et al, ACS Energy Lett, 2021, 6, 1490-1499, which describes harvesting wind energy using such a triboelectric nanogenerator in a high-speed train system. A triboelectric generator of this embodiment of the invention may therefore be constructed as described in Zhang et al, ACS Energy Lett, 2021, 6, 1490-1499, except that the composite material of the present invention is employed instead of the material used in Zhang et al.

Alternatively, the relative movement may be caused by a wave or waves. A wave as referred to herein is the movement of water in a direction such that it could cause a component of a generator of the invention to move. Therefore, a wave as referred to herein, encompasses an ocean/sea wave, tidal movement of water, flowing of a river or manmade body of water (i.e. canal), movement of a wake (i.e. movement of a region of disturbed flow, caused by the movement of a solid body through water).

The relative movement may alternatively be caused by machinery with a rotary motion, such as a turbine, washing machine, dryer, or combined washer dryer. Thus, the invention also provides a device comprising an electrical generator which comprises a transducer of the invention, wherein the transducer is a triboelectric generator, wherein the triboelectric generator comprises a tribo-negative element; and a first electrode, arranged to receive charge resulting from relative movement between the tribo-negative element and a tribo-positive element, wherein the tribo-negative element comprises said composite material, and wherein the relative movement comprises sliding a surface of the tribo-negative element against a surface of the tribo-positive element, wherein the sliding comprises rotational sliding, and optionally wherein the device is a machine capable of rotary motion, for instance a washing machine, tumble dryer, or combined washer dryer.

Alternatively, the device (for instance a washing machine, tumble dryer, or combined washer dryer) may utilize the non-contact (“free-standing”) mode. Thus, the invention also provides a device comprising an electrical generator which comprises a transducer of the invention, wherein the transducer is a triboelectric generator, wherein the triboelectric generator comprises a tribo-negative element; and a first electrode, arranged to receive charge resulting from relative movement between the tribo-negative element and a tribo-positive element, wherein the tribo-negative element comprises said composite material, wherein the triboelectric generator further comprises a counter-electrode, wherein the tribo-negative element is not in contact with the first electrode and is not in contact with the counter electrode, and the first electrode and the counter-electrode are the tribo-positive element, wherein the relative movement comprises moving the tribo-negative element relative to the first electrode and the counter-electrode to arrange the tribo-negative element alternately (i) closer towards the first electrode and further away from the counter-electrode, and (ii) closer towards the counter-electrode and further away from the first electrode, wherein said moving comprises rotational movement. Usually the device is a machine capable of rotary motion, for instance a washing machine, tumble dryer, or combined washer dryer.

The invention also provides a sensor which comprises a transducer of the invention. The transducer of the invention may be a triboelectric generator, as further defined herein.

The sensor of the invention may be a force sensor, a contact sensor, a proximity sensor, a movement sensor, a motion sensor, a pedometer, a tactile sensor, a tactile sensor for soft robots, or a sensor for a wearable device. A tactile sensor, as used herein, takes its normal meaning in the art, i.e. a tactile sensor is a device that measures information arising from physical interaction with its environment. The tactile sensor may be modelled on a part of the human or animal body, such as a limb, foot, hand or finger. A soft robot, as used herein, also takes its typical meaning in the art, i.e. a soft robot is a robot comprising compliant materials rather than rigid links.

Often, the sensor is flexible. Typically when the sensor is a sensor for a wearable device it is a flexible sensor.

The sensor of the invention may be a self-powered sensor.

The invention also provides a product which comprises at least one transducer of the invention, wherein the product is a keyboard, a morse code generator, a dance floor, sportswear, a biomedical implant, or a prosthetic. The transducer of the invention may be a triboelectric generator of the invention, as further defined herein.

A biomedical implant as described herein could be sensory implant, such as a cochlear implant, or intraocular lens; a cardiovascular implant, such as an artificial heart, artificial heart valve, implantable defibrillator, or a pacemaker; an electric implant for use in relieving pain for rheumatoid arthritis; or a contraceptive implant.

A prosthetic as referred to herein takes its usual meaning in the art, i.e. denotes an artificial body part. A prosthetic may be a limb prosthetic, such as an upper-extremity prosthetic, a lower-extremity prosthetic, a transfemoral prosthetic, or a transtibial prosthetic; or a joint replacement, such as a shoulder replacement, hip replacement, or knee replacement. In some embodiments, the product is self-powered.

Sportwear encompasses any clothing which may appropriately be worn for sport. An item of sportswear may be, for example, a top, a tracksuit, sports leggings, a skort, shorts, a sports bra, a trainer, a roller-skate, an inline skate, an ice-skate, a bodysuit, a leotard, a helmet, or a protective pad, e.g. a knee pad.

### Devices

The invention also provides a gas filtration device which comprises a composite material of the invention, i.e. a composite material which comprises a polymer matrix and, dispersed in the matrix, a metal organic framework, wherein the metal organic framework comprises a metal ion and an organic linker, wherein the organic linker comprises one or more electronegative substituent. The composite material may be as further defined anywhere herein. MOFs are known for their gas filtration ability due to their porous nature (Li et al., Chem. Soc. Rev. 2009, 38, 1477-1504). They have high potential for use in gas separation due to their large surface area, adjustable pore sizes, controllable properties and thermal stability. Embedding the composite of the invention in a polymer matrix, thus provides a useful composite material for gas filtration.

These properties are also excellent for separation and filtration in a liquid medium. Thus the invention also provides a water purification device which comprises a composite material of the invention.

The present invention also provides a catalyst which comprises a composite material of the invention. MOFs have been investigated and found to display excellent catalytic potential (Lee et al, Chem. Soc. Rev., 2009, 38, 1450-1459). Thus it is envisaged that a composite material of the invention, comprising a MOF as described herein, will be an efficient catalyst.

The invention also provides a luminescent device which comprises a composite material as defined herein. As discussed in Gutierrez et al. (Chem Rev., 2022, 122, 11, 10438-10483) MOFs incorporating luminescent guests can be useful in luminescent devices. Therefore the composite material of the invention would also be useful as a component of a luminescent device.

In each of these further aspects of the invention, the composite material may be as further defined anywhere herein.

### Method

The invention also provides a method of operating a triboelectric generator as defined herein, which method comprises causing the relative movement between the tribo-negative element and the tribo-positive element, in order to generate a potential difference between them due to a triboelectrification effect.

The movement can be caused mechanically, manually or by a natural phenomenon. The movement may be movement in any direction (i.e. in any plane) and at any speed (for example from 0.001 km/hour to 1000 km/hour).

The invention is further described in the Example which follows.

### Example 1

### Materials:

Zinc acetate (Zn(OAc)2·2H2O), 4,5-dichloroimidazole (dcIm), zinc oxide (ZnO), and methanol were purchased from Sigma-Aldrich. Sylgard 184 (polydimethyl siloxane (PDMS) elastomer and curing agent) was obtained from Dow Corning.

### Synthesis of MOF Particles:

(1) ZIF-71 nanoparticles were synthesized through a solution mixing method (Zhang et al, ACS Appl. Mater. Interfaces, 2020, 12, 37477-37488) performed under ambient conditions. 2.4 mmol of zinc acetate and 9.6 mmol of 4,5-dichloroimidazole were dissolved in 15 mL of methanol, respectively. After 1 h of homogenization, the two solutions were combined at ambient temperature and stirred for another 24 h to produce a white suspension product. The product was then centrifuged at 8,000 rpm for 10 min and washed three times in methanol to remove excess ligands. After drying at room temperature overnight, the resulting ZIF-71 powder was obtained.
(2) ZIF-72 nanoparticles were synthesized through a solvent-free, high-temperature method (Tu et al., Angew. Chem. Int. Ed., 2021, 60, 7553-7558). Initially, 2 mmol of zinc oxide powder was physically mixed with 6 mmol of 4,5-dichloroimidazole inside a 50 mL Schott bottle. Then the Schott bottle was capped and heated at 150° C. for 24 h. The as-synthesized powder was then washed with excessive methanol to clean out the unreacted ligands and then centrifuged at 10,000 rpm for 10 min. After three washing cycles, the yellowish ZIF-72 powder was dried overnight and collected.

### Preparation of ZIF/Polymer Nanocomposite:

The ZIF/PDMS composite film was prepared by doctor blade casting. PDMS elastomer was first mixed with the curing agent at a weight ratio of 10:1. The synthesized MOF particles (ZIF-71 and ZIF-72) were then added to the PDMS solution at different weight ratios of 0, 1, 2, 3, 4 and 5 wt %, respectively. After being dispersed homogeneously by a motor-driven blender overnight, the ZIF/polymer mixture was dripped on a glass substrate and casted by a doctor blade to obtain a film with uniform thickness. The cast film was then cured at 100° C. for 30 min in a vacuum oven and peeled off from the substrate. The prepared ZIF/PDMS composites were cut into small pieces with a dimension of 3 cm×3 cm for subsequent use. The average thickness of prepared nanocomposites is around 350 μm. As the skilled person will appreciate, this method may be employed or adapted for the purpose of incorporating any MOF described herein into any polymer matrix as described herein.

### Fabrication of TENG Devices:

TENG devices were fabricated in the contact-separation mode. To ensure a flat contact surface, a pair of 3D-printed boards with a contact area of 3 cm×3 cm was used as the substrate for TENG. The customized board was designed to have a uniform force distribution during oscillatory contact and low energy loss through jumper wires. A piece of aluminum (Al) foil was used as the negative electrode adhered to one of the boards by a double-sided adhesive. The prepared ZIF/PDMS nanocomposite film was then attached to the Al foil as the tribo-negative layer. Another piece of Al foil was pasted on the other board to act as both the tribo-positive layer and the counter electrode.

Three types of TENG devices were prepared by neat PDMS (P-TENG), ZIF-71/PDMS (Z71-TENG), and ZIF-72 PDMS (Z72-TENG). The periodic contact-separation movement of TENG was driven by a permanent magnet shaker (LDS V201) powered by a voltage-amplified arbitrary function generator (AFG-2105).

This device is representative of the “contact-separation mode” of the invention, as shown in FIG. 1.

Variations on the above method can be used to prepare MOFs of each mode. For example:

For “single-electrode mode” no counter-electrode is prepared, and a reference electrode is electrically connected to the tribo-negative layer. The tribo-positive element may not be part of the generator. For example, the tribo-positive element could be human skin. This is represented in FIG. 1.

For “sliding mode”, a dielectric material may be added to the counter-electrode as the tribo-positive element, and the tribo-positive element and the tribo-negative element are always in contact during operation. This is represented in FIG. 1.

For “free-standing mode”, two electrodes are standing in the same plane next to each other with a gap in between, and the tribo-negative element (i.e. the composite material of the invention) is placed above the electrodes not in contact with the electrode material (for example aluminium). In such a mode, the tribo-positive element is a separate element, not connected to the tribo-negative element. For example, the tribo-positive element could be a piece of aluminium foil, optionally pasted on a board. This is represented in FIG. 1.

### Characterization and Measurements:

The surface morphologies of prepared MOF materials were characterized by scanning electron microscopy (SEM; Hitachi TM3030Plus). The crystalline structures of MOF and nanocomposites were analyzed by X-ray Diffraction (XRD) using a Rigaku MiniFlex with a Cu K α source (1.541 Å). The topography of the prepared nanoparticles and nanocomposites were visualized by an atomic force microscope (AFM, Neaspec s-SNOM under tapping mode). A Nicolet iS10 FTIR spectrometer was used to record the Fourier-transform infrared (FTIR) spectrum. The far-IR spectroscopy was performed at the multimode IR imaging and microspectroscopy (MIRIAM) Beamline B22 at the Diamond Light Source synchrotron via a Bruker Vertex 80v FTIR spectrometer, equipped with an attenuated total reflectance (ATR) accessory (Bruker Optics, Germany). The water contact angle of films and powders was measured by a customized setup, and the images of water-film interfaces were processed by ImageJ. The dielectric measurements were assessed by an LCR meter (Hioki IM3536) with frequencies ranging from 4 Hz to 8 MHz. The substrate for TENG was fabricated by a 3D printer (Formlabs) using the Black V4 resin. The output voltage was measured by an oscilloscope (Rigol DS1054Z) with a 100 MΩ high voltage probe (Rigol RP1300H). The output current and charge transfer of the device were measured by an electrometer (Keithley 6514) and a multifunctional impedance spectrometer (Ivium.stat). The variation of electric potential was simulated using the finite element method (FEM) implemented in COMSOL Multiphysics software.

### Results and Discussion:

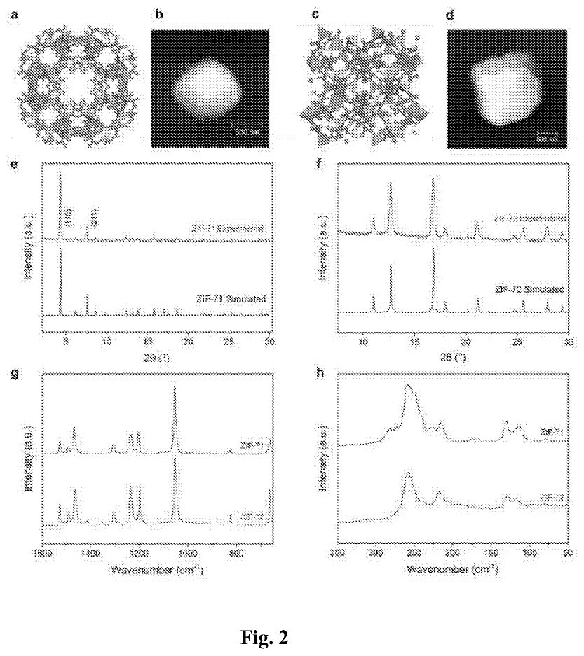

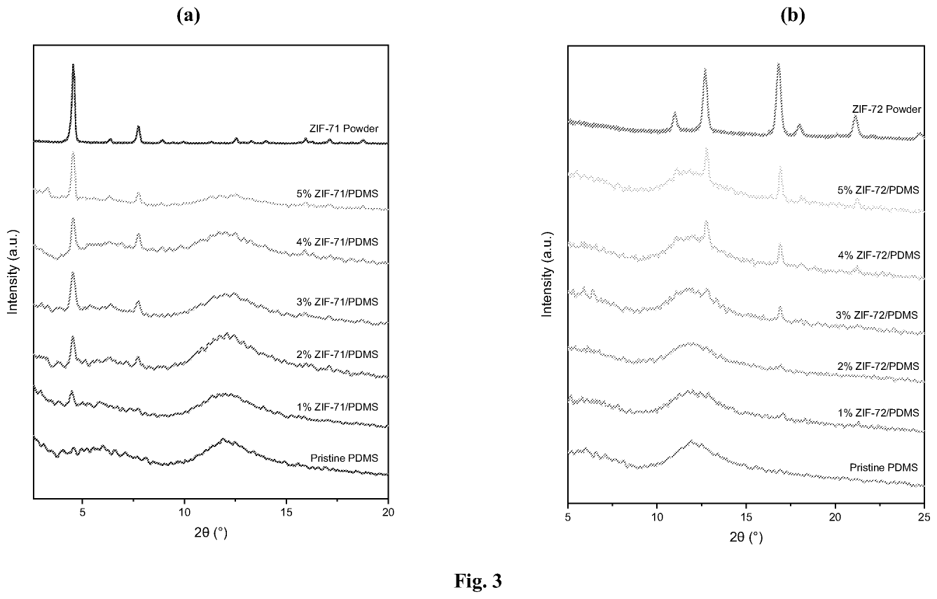

ZIF-71 and ZIF-72 nanoparticles are both articulated by the strong coordination bond between Zn2+ metal ion and the dcIm ligand as illustrated in FIGS. 2a and 2c. However, the variation of reaction conditions resulted in a completely different topology and other physical and chemical properties. The AFM height topography images of single nanoparticles of ZIF-71 and ZIF-72 are shown in FIGS. 2b and 2d. Both materials have a similar particle size of around 1 μm, though with dissimilar morphology. Specifically, ZIF-71 is a nanocrystal with a defined rhombic dodecahedron shape, whereas no specific morphology was observed for ZIF-72 nanoparticles due to its dense and non-porous structure. In addition, FIGS. 2e and 2f demonstrate the crystallinity of synthesized ZIF-71 and ZIF-72 nanoparticles, characterized by powder XRD technique. Both XRD patterns are consistent with simulated results which indicates the successful fabrication of the samples. The RHO topology of ZIF-71 nanoparticle shows main diffraction peaks at 2 a of 4.4° and 7.6°, whereas ZIF-72 with LCS topology have distinct peaks at 12.7° and 16.9°. Meanwhile, after incorporating MOF nanoparticles into PDMS matrix, the intensity of main diffraction peaks increases with higher MOF loading which demonstrates that the nanoparticles were well-mixed with the polymer matrix, and the crystalline structures of ZIFs were retained, as shown in FIG. 3.

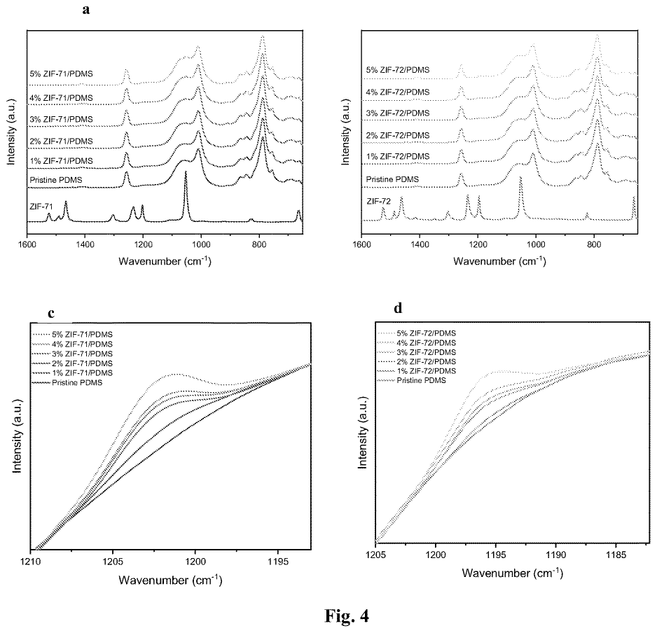

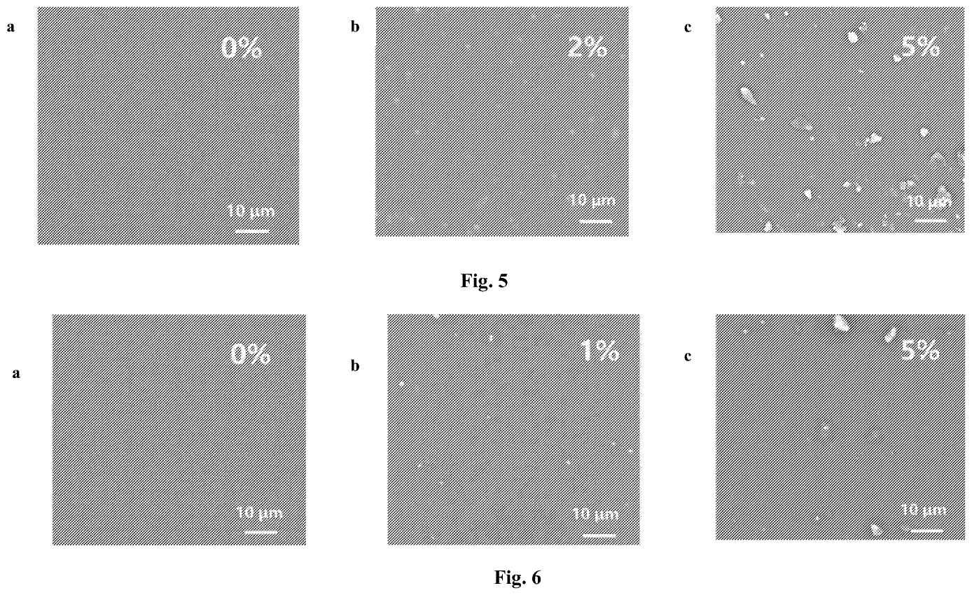

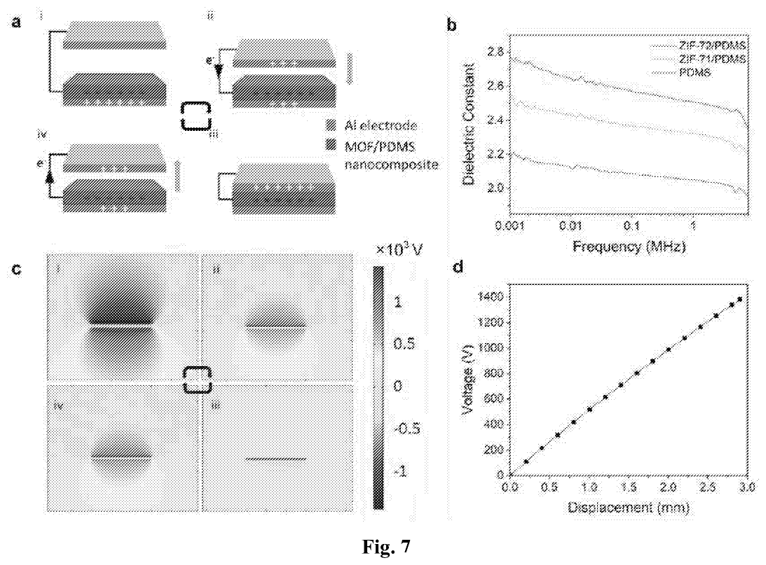

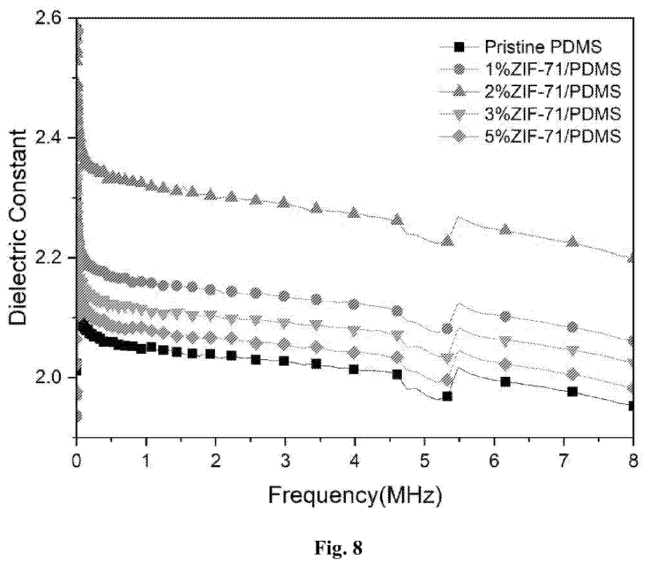

The FTIR spectra of prepared nanoparticles in both mid-IR and far-IR region are shown in FIGS. 2g and 2h, respectively. Due to the same constituting ligand and corresponding functional groups, ZIF-71 and ZIF-72 show similar vibrational modes. However, some minor differences are identifiable due to the difference in their coordination structure. The shifts of peaks are observed at 1466 cm-1 for N—CH bending, and 1202 cm-1 for CH bending. Some distinct peaks also exist for ZIF-72 at 1414 cm-1 and 1350 cm-1. Within the far-IR region, similar results are identified with subtle differences detected in the terahertz (THz) collective modes due to the metal-ligand interactions. Moreover, by incorporating the ZIF-71 filler into the PDMS matrix, there is no obvious band shifting observed from the FTIR spectra, which simply minimal chemical interactions between ZIF-71 and PDMS matrix and no decomposition of MOFs. The superimposed FTIR result shows a clearer view of the relationship between the peak height and the MOF concentration, as demonstrated in FIG. 4. The surface morphology of synthesized ZIF-71 and ZIF-72 nanoparticles and nanocomposites were visualized under SEM, as shown in FIGS. 5 and 6.

FIG. 7a illustrates the structure of a contact-separation mode TENG prepared by the MOF/PDMS nanocomposites. The prepared composite with a size of 3 cm×3 cm was sandwiched between the Al electrodes, acting as a tribo-negative layer for charge generation and charge storage. The working principle of a vertical contact-separation mode TENG can be explained using an electron transfer model (Li et al., Research (Wash D C), 2020, 2020, U.S. Pat. No. 8,710,686; Niu et al., Energy Environ. Sci., 2021, 60, 7553-7558). When two surfaces with opposite electron affinity are separated by a narrow gap, an electrical potential is created due to electrostatic induction, leading to equal but opposite charges on the positive and negative triboelectric surfaces. When two surfaces are in contact where a closed circuit is formed, this potential difference disappears and drives the electron to flow through the external circuit. Through alternative contact and separation, an AC output can be generated. For a conductor-to-dielectric contact-separation mode TENG, the potential difference between the triboelectric materials (AV) can be represented as (Yang et al., Adv. Energy Mater., 2016, 6, 1600505):

$$Δ V = {E}_{d} d + {E}_{air} x ( t ) = - \frac{Q}{S {ε}_{0}} ( {d}_{0} + x ( t ) ) + \frac{σx ( t )}{{ε}_{0}} \qquad ( 1 )$$

where E_{d} is the electrical field strength of dielectric material (in this case is the MOF/PDMS nanocomposite), d is the thickness of the dielectric material, x(t) is the distance between the plates with the variation of time, and Qis the electrical charge transferred between the two electrodes. ε₀ and ε_{d} are the permittivity of vacuum and the relative permittivity of the dielectric material, respectively. d₀ represents the effective thickness constant (d₀=d/ε_{d}), and σ is the surface charge density. Under open-circuit conditions, where no electric charge is transferred between the two electrodes (Q=0), the open-circuit voltage of TENG V_{OC} can be simplified as,

$${V}_{OC} = \frac{σ x ( t )}{{ε}_{0}} \qquad ( 2 )$$

From Equation 2, the surface charge density of the dielectric material is a crucial parameter to determine the output voltage, and can be further expanded to (Chen et al., J. Mater. Chem. A, 2022, 10, 799-807):

$$σ = \frac{{ε}_{0} {ε}_{d} {V}_{t r i}}{d} \qquad ( 3 )$$

where Vₜᵣᵢ is the triboelectric voltage dependent on the material itself. Therefore, according to the operating theory of TENG, the dielectric constant of material is considered as one of the most important properties for TENG output. FIG. 7b shows the dielectric properties of prepared pristine PDMS, ZIF-71/PDMS and ZIF-72/PDMS thin films under a broad range of frequencies from 4 Hz to 8 MHz. With the incorporation of ZIF-71 nanoparticles into the PDMS matrix, the dielectric constant is found to be improved, with the highest dielectric constant of 2.3 achieved at 2 wt % of ZIF-71 at a frequency of 1 MHz. On the other hand, incorporation of ZIF-72 further improved the dielectric constant up to 2.5 under a loading of 1 wt %. The higher dielectric constant of ZIF-72 nanocomposite compared with ZIF-71 can be explained by the non-porous structure of ZIF-72. Normally, a material with high volumetric density and highly polar molecular groups tends to have a higher dielectric constant (Chen et al., Annu. Rev. Mater. Res., 2015, 45, 433-458). Since ZIF-71 and ZIF-72 nanoparticles comprise the same ligand with abundant and polar C-Cl bonds, the difference in their volumetric densities in consequence of their structural topology played a critical role to their dielectric constants. For ZIF-71, the existence of its nanopores hindered its polarizability. As air is a medium of the lowest dielectric constant (Li et al., Nat. Commun., 2016, 7, 11830), the encapsulation of ambient air into these pores will reduce the dielectric property. In contrast, ZIF-72 with absence of porosity has a much denser morphology and less void fraction. The theoretical density of ZIF-72 based on its crystalline structure is 1.77 g cm-3, whereas ZIF-71 has a much smaller density of 1.15 g cm-3. Therefore, the high volumetric density of ZIF-72 leads to a better dielectric property. Both MOFs improved the dielectric constants of PDMS film with a similar tendency. This increment of dielectric constant is caused by the formation of micro-capacitors as nanoparticles are incorporated into the polymer matrix. The nanoscale capacitor networks increased the polarizability of the prepared nanocomposite material and as a result, improved the dielectric properties. However, as the MOF loading increases beyond a threshold value, a drop of dielectric constant can be observed. The reduction of dielectric constant at higher filler loading can be explained by the percolation theory (Rana et al., Nano Energy, 2021, 89, 106355; Li, et al., Nano Res., 2022, 15, 8458-8464). When the material loading exceeds the percolation threshold, the compact distribution of MOF nanoparticles will form a conductive path within the polymer matrix, allowing electrons to transfer through directly, thereby lowering the dielectric Constant (Shaukat et al., Nano Energy, 2022, 96, 107128). A COMSOL simulation was performed using FEM to model the electric potential generated between the two electrodes of TENG, as shown in FIG. 7c. The electric potential generated during operation is in agreement with the working mechanism schematic (FIG. 7a), which is also proportionally correlated with the distance between the two triboelectric materials, as shown in FIG. 7d. In this study, a separation gap of 3 mm is selected to generate a considerably higher electrical output, meanwhile reducing the overall size of the device.

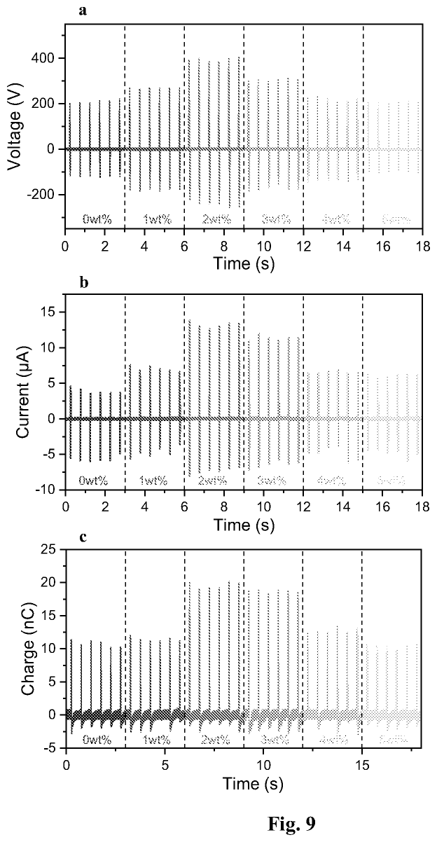

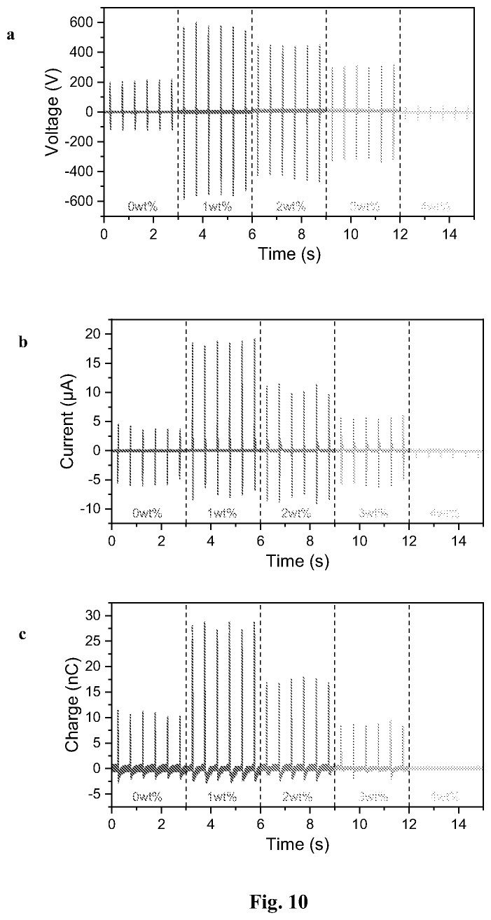

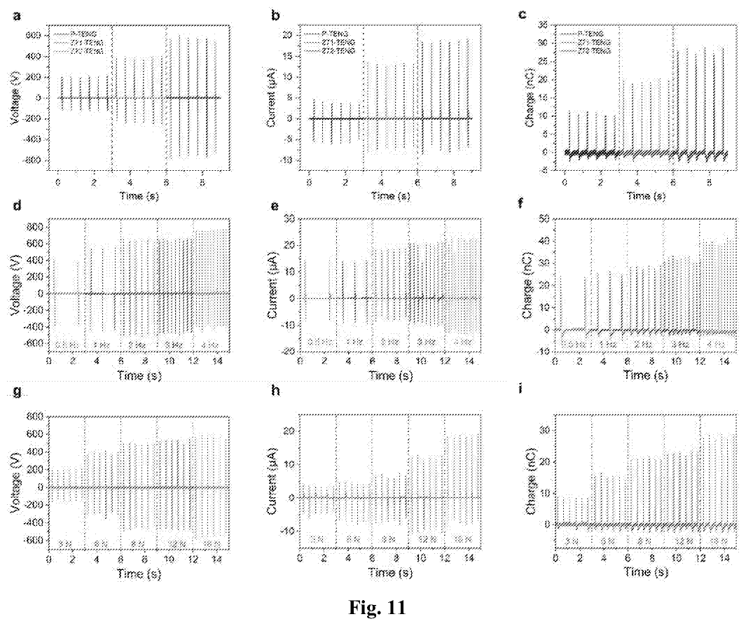

The output performance of the assembled MOF-TENG was tested on a customized test bench to understand the effect of nanoparticle embedment. The open-circuit voltage, closed-circuit current, and charge transfer between the electrodes of TENG were measured for both Z71-TENGs and Z72-TENGs at different mass loadings. FIGS. 9 and 10 demonstrated the relationship between the filler loading in polymer matrix and the electrical performance of the device. For Z71-TENG, it was identified that a 2 wt % mass loading exhibits the most outstanding electrical performance with nearly doubled improvement of all electrical properties compared with the neat PDMS film. Besides, the Z72-TENGs show a similar trend to ZIF-71, with the highest power output observed at 1 wt % loading. An exceptionally high electrical output was obtained with a peak-to-peak voltage over 1139 V and a peak current of 19 μA, over 4 times higher than the neat PDMS film under the same test conditions. It is also worth to notice that a reduction of output power was observed at higher MOF loadings. This decrement can be attributed to the aggregation of nanoparticles at a higher mass concentration within the polymer matrix, which can also be observed under SEM, as shown in FIG. 5. The nanoparticle aggregates created a channel for the electron flow which lowered the dielectric property of the composite. In addition, the immobilization of the observed aggregation structures reduced the polarizability of the material, thereby affecting the charge trapping capability of nanoparticles. To have a closer look at the effect of embedding MOF nanoparticles into a triboelectric material matrix, the films of the highest electrical output were selected and compared with the pristine PDMS film, as shown in FIG. 11a-c. The embedment of MOFs shows excellent improvement in the electrical performance attributed to the charge generating and charge trapping properties of hydrophobic MOF nanoparticles. The presence of chlorine atoms in the ligand of ZIF-71 and 72 induced high electronegativity (Huheey, J. Phys. Chem., 1965, 69, 3284-3291), hence improving the charge-generating capability of the prepared composites. Moreover, more trapping sites are created by the uniform distribution of nanoparticles within the polymer matrix which can facilitate the charge transfer and charge storage within the material. These trapping sites also hinder the charge recombination effect at the material surface during contact, whereby drawing more charges to the inner structure of the material. As a result, more induced charged can be collected at the chlorinated groups of ZIF-71 and ZIF-72 nanofillers, thereby enhancing the overall charge density of the material.

In addition to the study on the effect of mass loading, the frequency dependency of the electrical performance was also investigated under a range of frequencies from 0.5 Hz to 4 Hz generated by the magnetic shaker. Results in FIG. 11d-f indicated that the output voltage and current of the Z72-TENG showed a trend of increasing proportionally as the input frequency varies up to 4 Hz. Moreover, the influence of the applied force on the output performance was investigated under varying forces from 3 to 16 N at a 2 Hz input frequency. The force of the impact was controlled by the voltage supplied to the magnetic shaker and measured by a calibrated force transducer. The results shown in FIG. 11g-i imply that the output voltage, current, and charge increased almost linearly as the input force increased. Therefore, there is high potential for the as-fabricated Z72-TENG to perform as a self-powered force sensor, and it is worthwhile to further investigate this avenue.

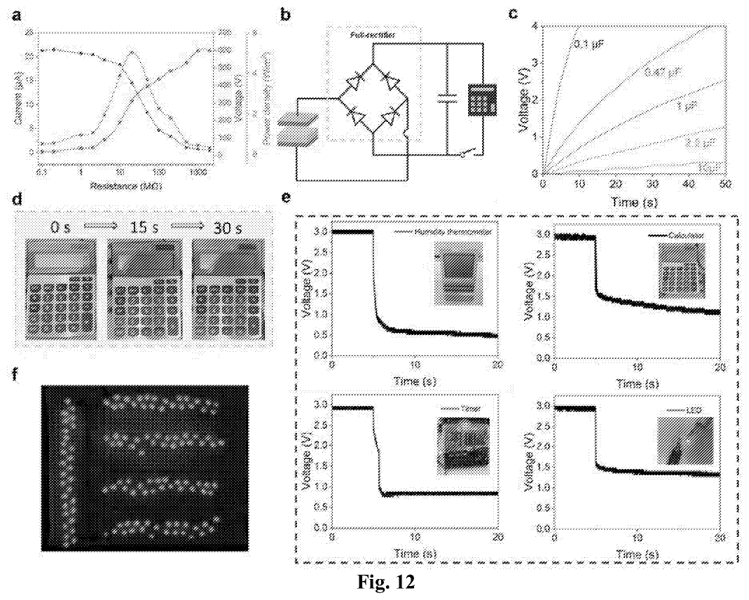

The prepared MOF-TENG devices were then connected into a closed circuit with varying load resistances to examine the optimum operating conditions and validate the practicability for real-world applications. Under a constant input frequency of 2 Hz and a compression load of 20 N, the peak closed-circuit voltage (V) and current (I) across the load resistor were measured, with power density P_{d} calculated using the equation P_{d}=(VIA), where A is the effective contact area. As shown in FIG. 12a, the Z72-TENG achieved a maximum power output of 5.03 W/m² under a load resistance of 20 MΩ, with measured voltage and current showing an inverse relationship due to ohmic loss. It is worth noting that the optimum operating resistance of Z72-TENG is lower than pure PDMS based TENG reported in other studies due to the improved capacitance by the addition of ZIF-71 (Rahman et al., Nano Energy, 2022, 94, 106921). This optimum resistance corresponds to the internal resistance of the generator, where a low impedance can lead to a broader application in real life (Vijayakanth et al., Angew. Chem. Int. Ed., 2018, 57, 9054-9058). Furthermore, the achieved improvement in voltage, current, and output power density by Z72-TENG is compared with other reported works of PDMS based TENG, as illustrated in Table 1, below. Although the experimental setup in each study is different in frequency, force, and exact configuration, it is still evident that the open-circuit voltage, short-circuit current and power density of Z72-TENG prepared in this work are superior to other PDMS-based TENGs.

TABLE 1

| | | | | | | | | Max | | |
|---|---|---|---|---|---|---|---|---|---|---|
| Name of | Polymer | | Positive | P-P | | | | Power | | |
| device | matrix | Filler | layer | Voltage | | Current | | Density | | Reference |
| Silver | PDMS | AgNW | PFA | 203 | V | 22 | μA | — | | Kang, H., et al., |
| Nanowires | | | | | | | | | | Adv. Funct. |
| TENG | | | | | | | | | | Mater., 2016. |
| | | | | | | | | | | 26(42): p. |
| | | | | | | | | | | 7717-7724. |
| CNT- | PDMS | Aligned | ITO | 275 | V | 54 | μA | 4700 | mW m⁻² | Wang, H., et al., |
| PDMS | | CNT | | | | | | | | Nanoscale, |
| TENG | | | | | | | | | | 2016. 8(43): p. |
| | | | | | | | | | | 18489-18494 |
| 3D- | PDMS | 3D-Mxene | Nylon | 65 | V | 0.6 | μA | — | | Wang, D., et al, |
| MXene/ | | | | | | | | | | al., Compos. A: |
| PDMS | | | | | | | | | | Appl. Sci. |
| TENG | | | | | | | | | | Manuf., 2020. |
| | | | | | | | | | | 130: p. 105754. |
| F-MOF | PDMS | KAUST-8 | Al | 530 | V | 3.2 | μA | 520 | mW m⁻² | Guo, Y., et al., |
| TENG | | | | | | | | | | Nano Energy, |
| | | | | | | | | | | 2020. 70: p. |
| | | | | | | | | | | 104517. |
| Perovskite- | PDMS | Sr₃CO₂WO₉ | Al | 300 | V | 2.2 | μA | 305 | mW m⁻² | Sahu, M., et al., |
| TENG | | (SCWO) | | | | | | | | Mater. Today |
| | | | | | | | | | | Energy, 2021. |
| | | | | | | | | | | 20: p. 100639 |
| ZIF-TENG | PDMS | ZIF-8 | Cu | 176 | V | 16.3 | μA | 1764 | mW m⁻² | Wen, R., et al., |
| | | | | | | | | | | Nanotechnology, |
| | | | | | | | | | | 2021. 32(34): |
| | | | | | | | | | | p. 345401 |
| SWCNT- | PDMS | SWCNT and | Teflon | 90 | V | 2.5 | μA | 117 | mW m⁻² | [Zhao, X. and |
| IL-PDMS | | IL | | | | | | | | Z. Ounaies, |
| TENG | | | | | | | | | | Nano Energy, |
| | | | | | | | | | | 2022. 94: p. |
| | | | | | | | | | | 106908 |
| Z72- | PDMS | ZIF-72 | Al | 1139 | V | 19 | μA | 5028 | mW m⁻² | This Work |

TENG

To verify the effectiveness of TENG as an energy harvester, the alternative current produced by TENG was harvested and stored into capacitors through a full rectifier circuit, shown in FIG. 12b. After induced charges passing through the rectifying circuit, the alternating current was converted to direct current by a network of diodes, therefore reducing the energy loss during the charging process. The rectified current can be subsequently used to charge up capacitors and other commercial electronics. As shown in FIG. 12c, several commercial capacitors with capacitances ranging from 0.1 μF to 10 μF were charged by a steady 2 Hz oscillation motion and 20 N compression load. A reasonably high charging voltage can be attained for all capacitors after a relatively short time, with less charging time required for smaller capacitors. The result shows a charge voltage of 10 V for a 0.1 μF capacitor within 15 s which suggests the feasibility to redistribute the stored electricity to other electronics. For verification, a 47 μF capacitor was first charged to 3 V by the Z72-TENG and subsequently used to power up microelectronics, including a humidity thermometer, a digital timer, a calculator, and an LED. The charge-discharge curves for different electronics are displayed in FIG. 12e. As the selected electronics have distinct operating voltage and power consumption rates, the time of activation for each electronic was also recorded. The capacitor successfully activated all electronics, with the calculator having the longest standby time among the four, where the number on screen remained visible after 30 s of operation, as shown in FIG. 12d. The illumination of 120 LEDs by as-fabricated Z72-TENG was also demonstrated in FIG. 12f.

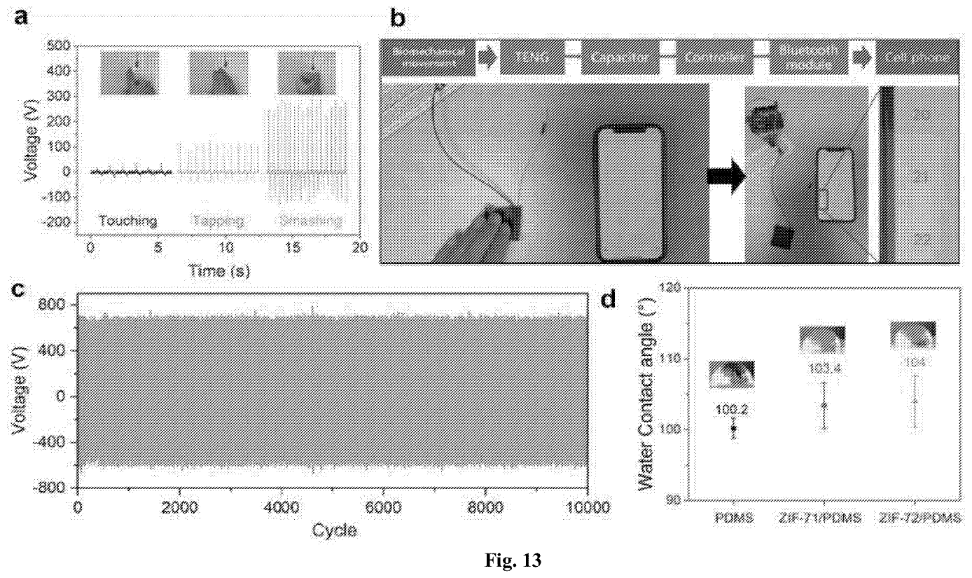

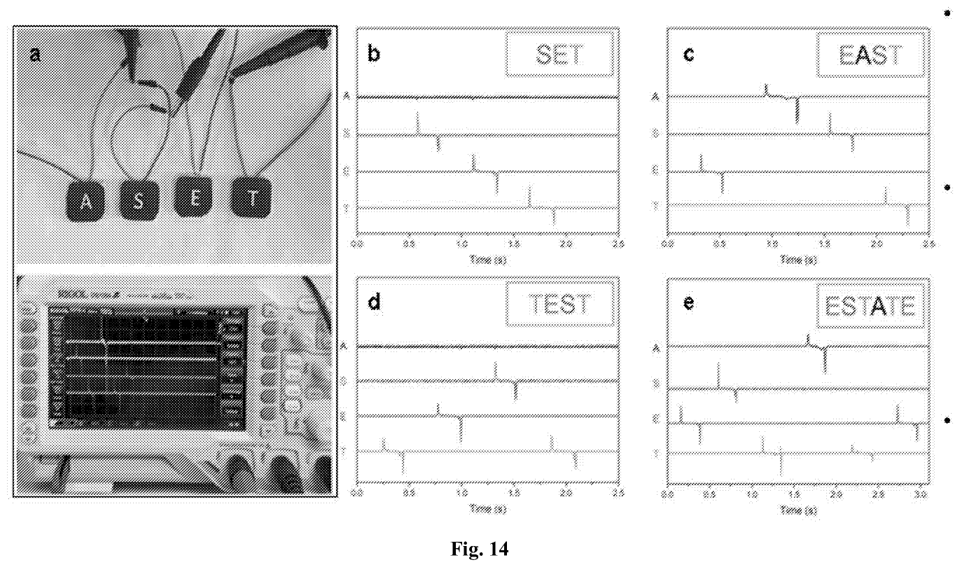

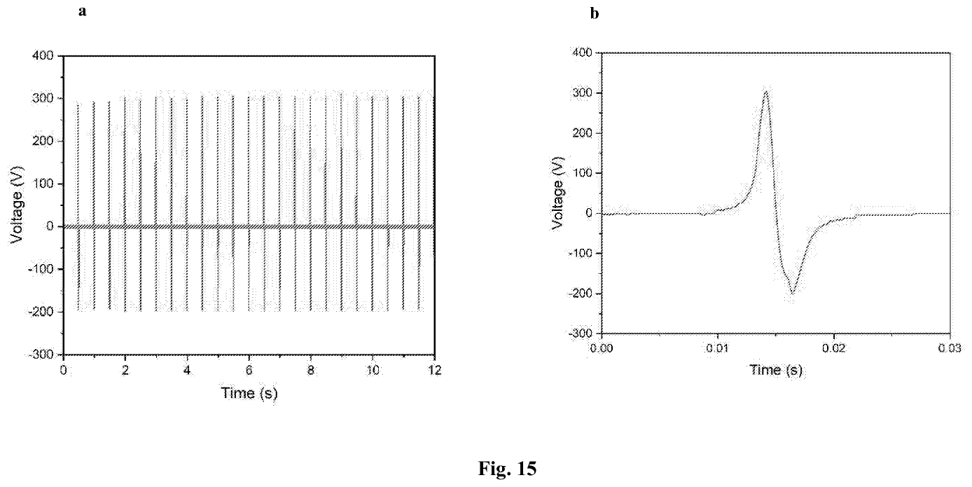

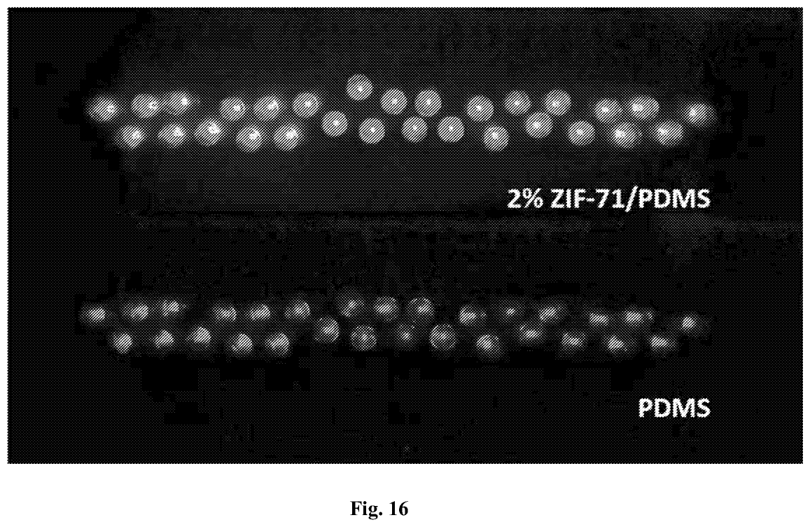

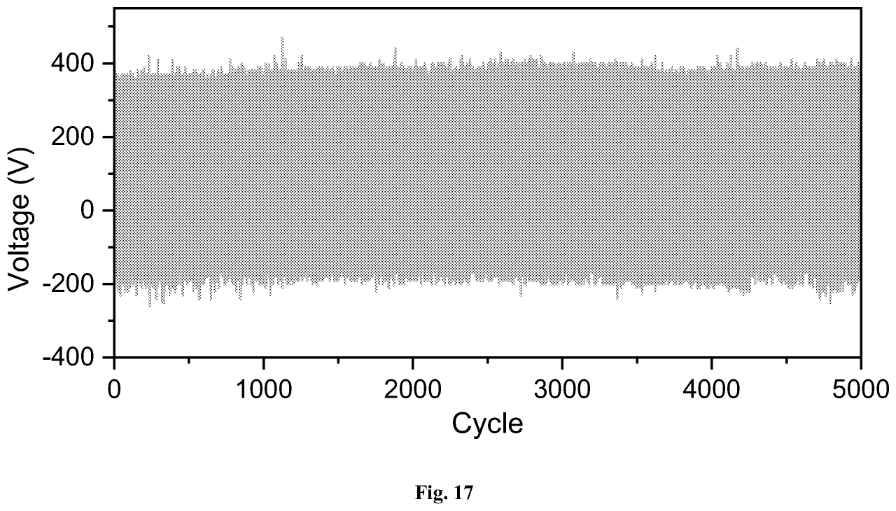

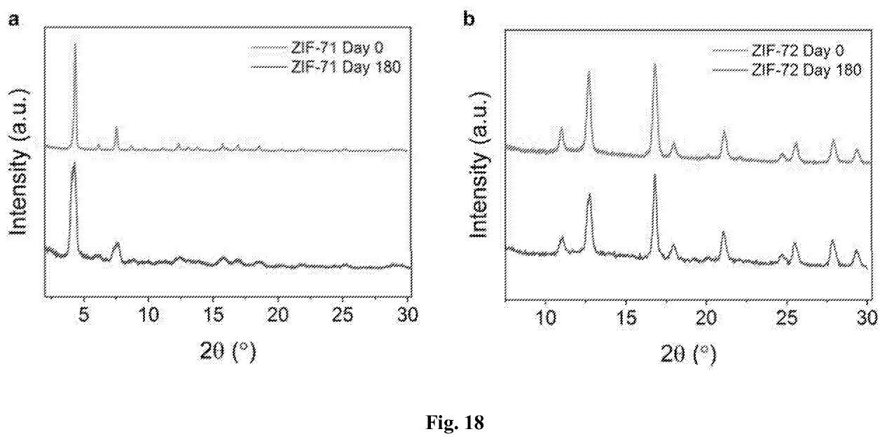

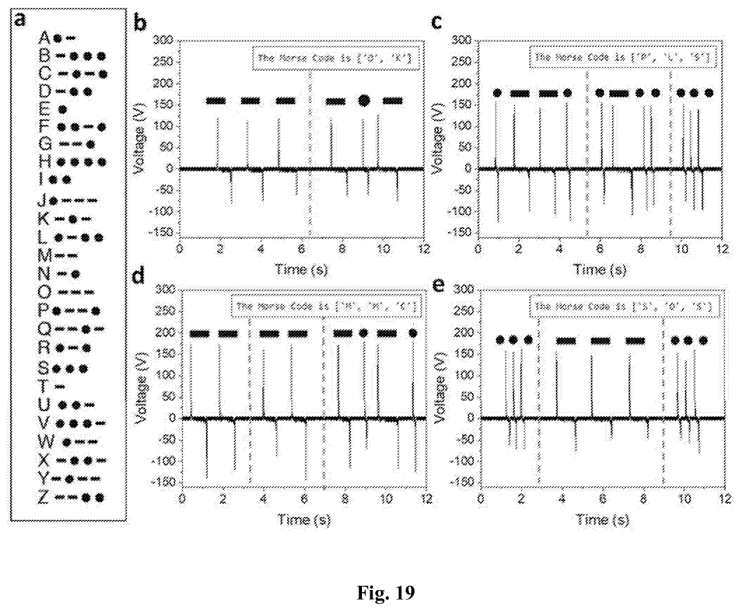

The prepared Z72-TENG devices were further tested outside a laboratory setting, where random mechanical motions in real life were harvested. To improve the compatibility of TENG in practical scenarios, the triboelectric material was attached on a flexible substrate instead of a hard 3D-printed board. In addition, by removing the top electrode of the contact-separation mode TENG, a single electrode mode Z72-TENG was fabricated for more versatile applications (Manjari et al., Mater. Lett., 2022, 312, 131644). FIG. 13 illustrates the operation of TENG from daily human motions, such as touching, tapping, and smashing. The latex glove on the hand acted as a tribo-positive material, thereby transferring charges to the bottom electrode when in contact with prepared ZIF-72/PDMS film. Since the tested biomechanical motions were under different contact forces, different voltages were generated with proportional relationship to force. The single electrode TENG showed a sensitive response towards daily motions that a nominal voltage of around 30 V can be generated even by gentle touching. This demonstration proves the potential application of Z72-TENG to monitor different body motions as well as to harvest energy for the powering of portable electronics.

In addition to its application as an energy harvester, the prepared Z72-TENG is also examined as an effective sensor to monitor the surrounding mechanical motions. Here, a prototype for a small TENG-based pedometer is designed to transmit output signal remotely via Bluetooth, as shown in FIG. 13b. The prototype constitutes of a ZIF-based TENG device, a capacitor, a Bluetooth module, and a central Arduino controller. During operation, a mechanical motion to the TENG device triggered a small electrical signal to charge the capacitor, where this trivial change in the voltage of capacitor was captured and processed by the central controller to generate a pulse signal. With a Bluetooth module integrated to the controller and connected to a mobile software, the stimuli signal was recorded and displayed on a remote device. The operation of the pedometer by tapping the TENG device shows good sensitivity towards the frequency and the force of mechanical motion, demonstrating its excellent potential for self-powered sensing applications.

Durability is one of the most important requirements for a TENG device since a long working time and stable power output is crucial for practical implementations. To verify the robustness of TENG, the variation of its voltage output over a continuous running of 1.5 h under a 2 Hz oscillation was recorded in FIG. 13c. The prepared TENG shows excellent durability with a stable voltage of around ±600 V being delivered throughout the test without noticeable degradation, which further demonstrated its potential for real-world application. Moreover, humidity is considered another obstacle to the long-term stability of a TENG device, as the intrusion of water at the tribo-material interface will significantly hinder the charge transfer (Nguyen et al., Nano Energy, 2013, 2, 604-608). As illustrated in FIG. 13d, the water contact angles of nanocomposites were measured to investigate their performance under humid conditions. Both ZIF-71/PDMS and ZIF-72/PDMS nanocomposites show improved hydrophobicity comparing with neat PDMS film, increasing the water contact angle of PDMS film from about 100° to 104°. Thus, the prepared ZIF TENGs demonstrated a good robustness under harsh conditions which opened the way for more practical applications.

In summary, this Example demonstrates the embedment of chlorinated ZIFs into a PDMS polymer matrix to fabricate durable TENG devices with outstanding power density. Owing to the high surface charge density and large surface area of hydrophobic ZIFs, the charge generating and charge trapping properties of their nanocomposites are remarkably improved. In addition, the effect of ZIF-71 and ZIF-72, two MOFs of same constituting components but different topology were compared to explore the effect of porosity and dielectric constant to the triboelectric property. Among all fabricated MOF-TENG devices, an optimum mass loading of 1 wt % ZIF-72 in PDMS was found to generate the highest electrical output of 578 V and 19 μA, much higher than the pristine PDMS film. An instantaneous power density of 5.03 W m-2 was also achieved under an external load of 20 MΩ. To validate the practical applications of fabricated TENG devices, capacitors with different capacitances and commercial electronics were powered by the operation of Z72-TENG. Lastly, a prototype for a Bluetooth-integrated pedometer was constructed which demonstrated great potential for other innovative, real-world applications.

### Example 2

### Halogenation of Constituting Ligand of Zeolitic Imidazolate Frameworks

Isostructural ZIF-8-X (X═CH₃, Br, Cl) nanoparticles were incorporated into polyvinylidene fluoride (PVDF) electrospun fibers and assembled in TENG devices to investigate the underlying relationship between functional group electronegativity (via varied imidazolate linkers) and triboelectric output performance.

Results show that ZIF-8-Cl/PVDF composite fibre demonstrated the highest voltage and current output of 312 V and 4.96 μA, which are 3.8 and 5.5 times higher than that of the pristine PVDF. Furthermore, the peak power density of ZIF-8-Cl/PVDF based TENG exceeds the traditional PVDF fibre by 8.2 times, demonstrating excellent potential for real-world applications. The practicality of ZIF-8-X based TENG was tested for harvesting energy from oscillatory motions to power up LEDs and capacitors. The relationships between electrical performance and multiple operating parameters (pressure, frequency, displacement) were studied in detail. The working mechanism of ZIF-8-X based TENG was also revealed through nanoscale-resolved chemical studies and theoretical simulations, providing valuable insights on the design of MOF materials for improved performance of TENGs.

### Synthesis of ZIF-8 Derivatives

### Materials:

All chemicals used were commercially available. Zinc nitrate hexahydrate (Zn(NO3)2·6H2O), 1-methylimidazole, dimethylformamide (DMF), ethanol, and methanol were purchased from Sigma-Aldrich. 2-Bromo-1H-imidazole and 2-chloro-1H-imidazole were purchased from Doug Discovery. HSV900 polyvinylidene fluoride (PVDF) was purchased from Arkema.

### Synthesis of ZIF-8 Derivatives:

(1) For the synthesis of ZIF-8-CH₃ nanoparticles, 350 mg of zinc nitrate hexahydrate (1.2 mmol) was first dissolved in 15 mL of DMF. After sonication for 5 min, 200 mg of 1-methylimidazole (2.5 mmol) was added to the solution and stirred for another 5 min for complete dissolution. Afterward, the solution was transferred to a 20 mL PTFE-lined stainless-steel autoclave and heated at 100° C. for 72 hr. After cooling to room temperature, the resulting white suspension was centrifuged and washed three times with methanol to remove excessive linker and solvent. ZIF-8 powder was harvested and activated at 70 C.
(2) For ZIF-8-Br synthesis, 121 mg of Zn(NO₃)₂(0.4 mmol) and 2-bromo-1H-imidazole (120 mg, 0.8 mmol) were dissolved in 4 mL of ethanol. Then the solution was transferred to a 20 mL PTFE-lined stainless-steel autoclave and heated at 100° C. for 72 hr. Then the same reaction protocol and washing process were followed to yield 60 mg of a yellowish powder.
(3) A similar procedure was followed to prepare ZIF-8-Cl. 121 mg of Zn(NO₃)₂(0.4 mmol) and 2-chloro-1H-imidazole (120 mg, 0.8 mmol) were dissolved in 4 mL ethanol by stirring for 10 min. The synthesis and washing procedures were the same as previously followed by ZIF-8-Br. 50 mg of yellowish powder was obtained after drying.

### Fabrication of MOF/PVDF Composites:

The MOF/PVDF composites were prepared by the electrospinning technique. The PVDF solution used for electrospinning was prepared by dissolving 13.7 wt % of HSV900 PVDF powder in DMF solution. The prepared ZIF-8-X nanoparticles were then mechanically mixed with PVDF solution to yield a mass ratio of 1:19 between ZIF-8-X and HSV900 PVDF powder. The homogenized solutions were stored in a glass syringe and gradually released by a syringe pump at a rate of 0.15 mL/hr through a nozzle (conductive blunt tip). During operation, the blunt tip was electrified at a voltage of 15 kV by a high voltage generator, with an aluminium foil placed 16 cm under the nozzle as the negative charge collector. After 1 hr of electrospinning to obtain the desired thickness, the electrospun membrane was then peeled off and dried. The nanofiber produced by the high voltage formed uniform composite fibre without obvious aggregation. The fibres are subsequently cut into dimensions of 2 cm×2 cm for the fabrication of TENG devices.

### Testing of TENG Devices

Aluminium foils of 2 cm×2 cm in size were attached to the centre of PET substrates with dimensions of 3 cm×3 cm. Then, the fabricated MOF/PVDF composite fibre was sandwiched between a pair of Aluminium foils. Four TENG devices were prepared by PVDF, ZIF-8-CH₃/PVDF, ZIF-8-Br/PVDF, and ZIF-8-Cl/PVDF. For a standard test, a prepared TENG device was vertically attached to the sample holder connected to a load cell (RS PRO). A permanent magnet shaker (Bruel & Kjor LDS V201) powered by a voltage-amplified arbitrary function generator (GW Instek AFG-2105) was operated on the other side of the TENG device to generate the contact-separation motion.

### Characterization

A field-emission scanning electron microscope (FESEM LYRA3 GM TESCAN) was used to analyze the surface morphologies of prepared MOF and MOF/PVDF composite materials. A Rigaku MiniFlex with a Cu Kα source (1.541 Å) was used to obtain the crystallinity information of prepared samples by the X-ray diffraction (XRD) technique. The atomic force microscope (AFM) height topography and nano-FTIR spectra of the nanoparticles and nanocomposites were characterized by a scattering-type scanning nearfield optical microscope (Neaspec s-SNOM). The Fourier-transform infrared (FTIR) spectroscopy was performed by a Nicolet iS10 FTIR spectrometer equipped with an attenuated total reflectance (ATR) module. The far-IR spectrum was recorded at the multimode IR imaging and microspectroscopy (MIRIAM) Beamline B22 at the Diamond Light Source synchrotron. A Bruker Vertex 80v FTIR spectrometer equipped with an ATR accessory (Bruker Optics) was used to perform the measurement. The electrical output including voltage and current were measured by a digital oscilloscope (PicoScope 5444B) with a 100 MΩ high voltage probe (Rigol RP1300H) and an electrometer (Keithley 6514).

### Results and Discussion

### Material Characterisation of ZIF-8-X

A group of functionalized ZIF-8-X materials was synthesized by a solvothermal method under the same reaction time and temperature but with different functional groups (X═—CH₃, —Cl, —Br) as shown in FIG. 20.

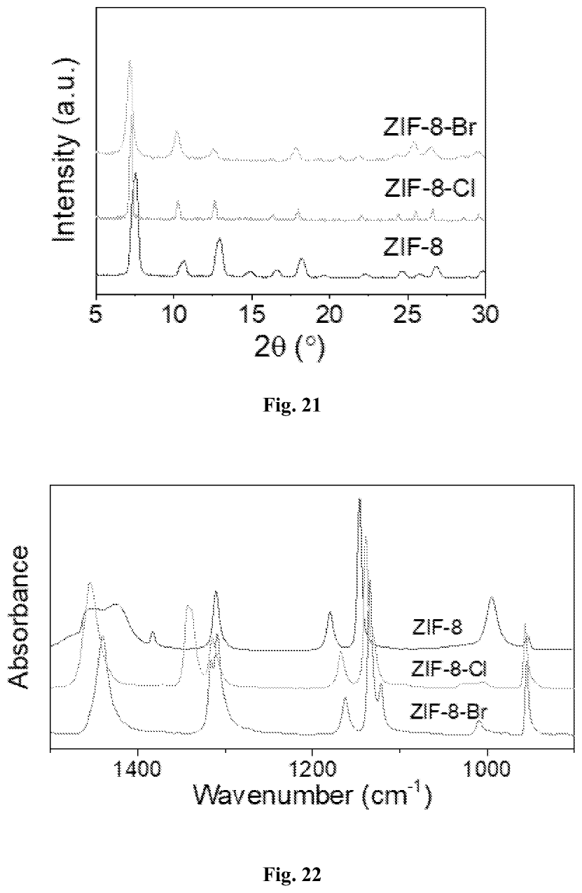

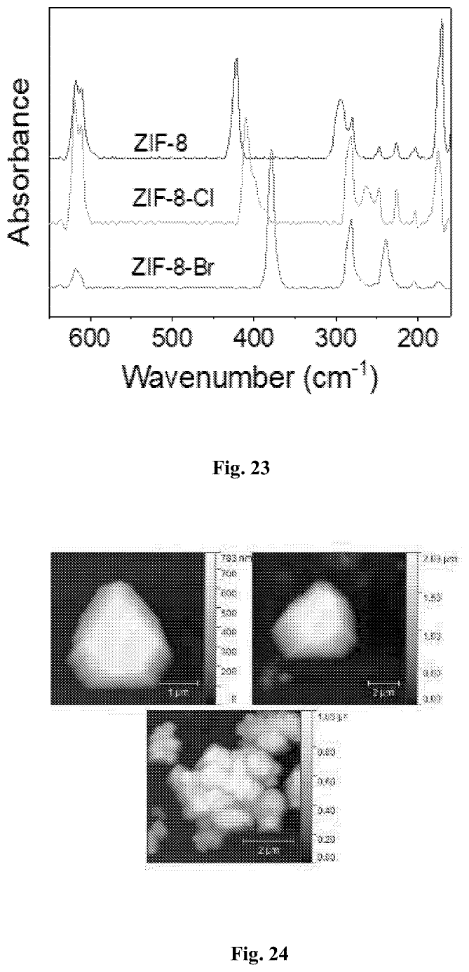

The X-ray diffraction (XRD) is used to characterize the crystallinity of synthesized ZIF-8-X as shown in FIG. 21. All synthesized MOFs show facets on (110) (200) and (211) which confirms the successful formation of the same sodalite (SOD) topology and well agree with the simulated results. It is observed that the (110) facet diffraction peak for ZIF-8-CH₃ to ZIF-8-Cl and ZIF-8—Br are at 7.54°, 7.29° and 7.17°, respectively. This shift to the smaller diffraction degree means a larger porosity of the framework is formed due to the expansion of the structure by the larger end groups of the constituting ligand. Moreover, the XRD patterns of ZIF-8-X nanoparticles differ by the relative intensities at (100), (200), and (211) facets, which is due to the different X-ray diffraction factors induced by the linker substitution. In FIG. 22, the FTIR spectra of ZIF-8-X nanoparticles look almost the same despite some redshifts of peaks as the linker gets bulkier. The shifts of peaks were observed at around 1150, 750, and 670 cm⁻¹, where these peaks are attributed to the imidazole ring vibrations due to different interactions between the end group and the imidazole ring. As the functional group of the framework gets heavier from CH₃ to Cl and subsequently to Br, the vibration frequency reduces and lowers the wavenumbers. The far-IR spectra shown in FIG. 23 reveal the metal-ligand interactions at the terahertz region. Similar to ATR-FTIR, the peak at ~400 cm⁻¹ shifts towards a smaller wavenumber due to the larger framework.

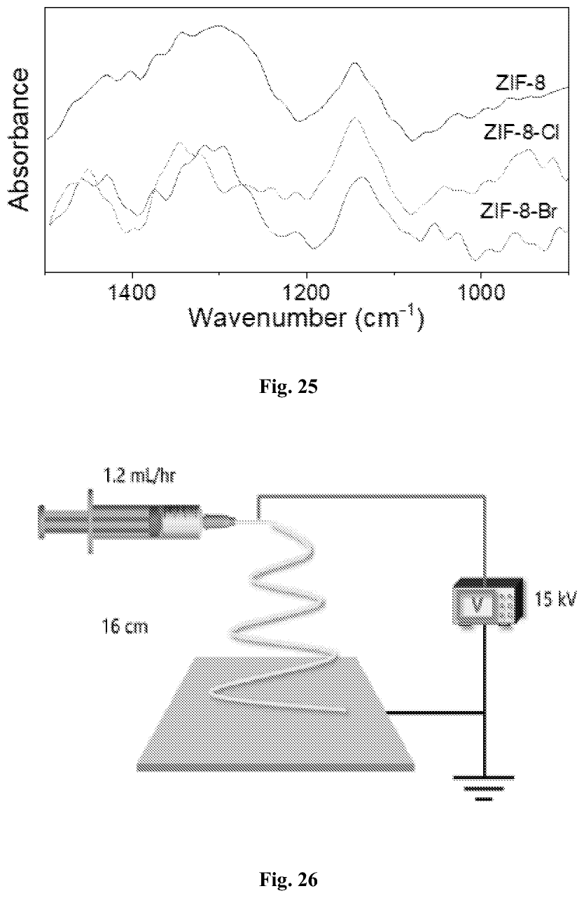

The chemical bond vibrations of synthesized ZIF-8-X are also characterized by nano-FTIR technique, as shown in FIGS. 24 and 25. The height topography images of ZIF-8-X demonstrate the particle morphologies and nano-FTIR was taken on the MOF crystal with 20 nm spatial resolution. The same redshift pattern is observed in the nano-FTIR spectra at ~1150 cm⁻¹ due to the bulkier functional group.

### Material Characterisation of ZIF-8-X/PVDF Composites

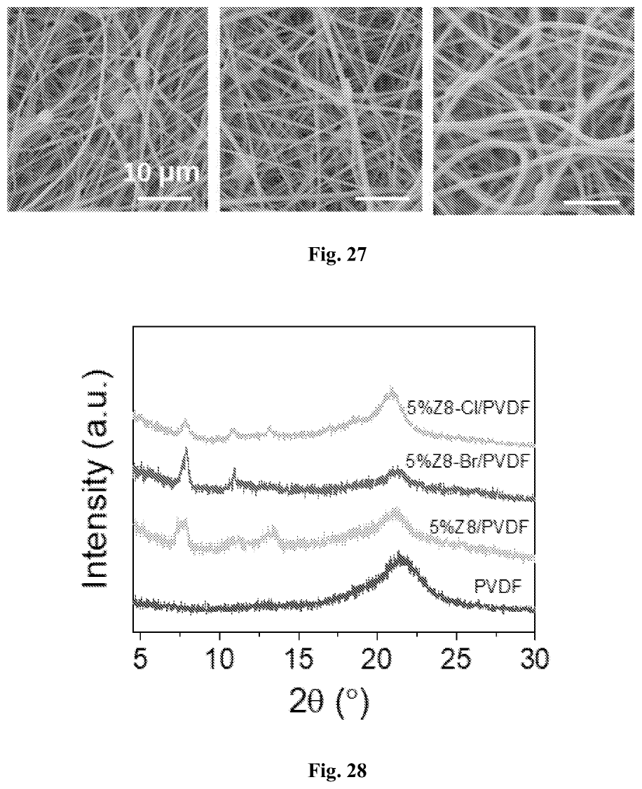

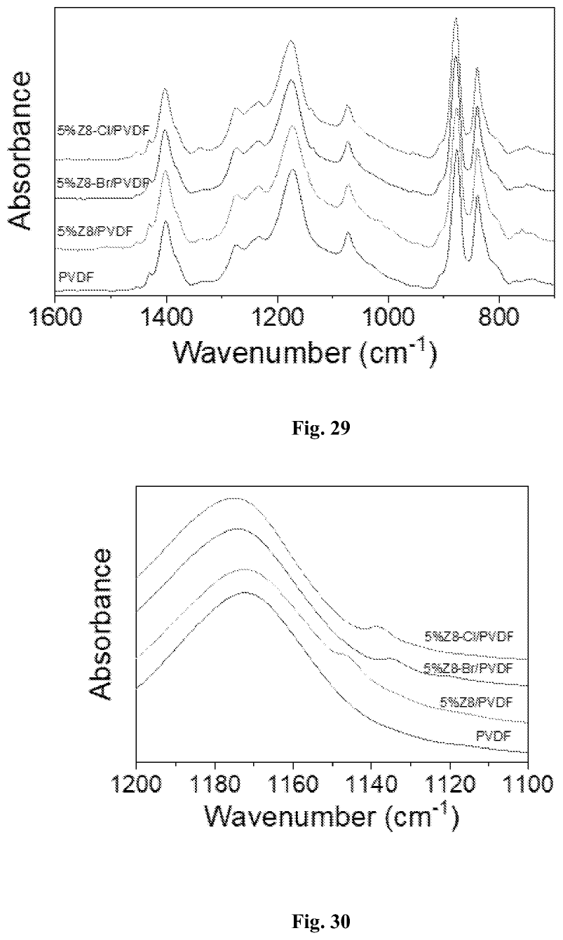

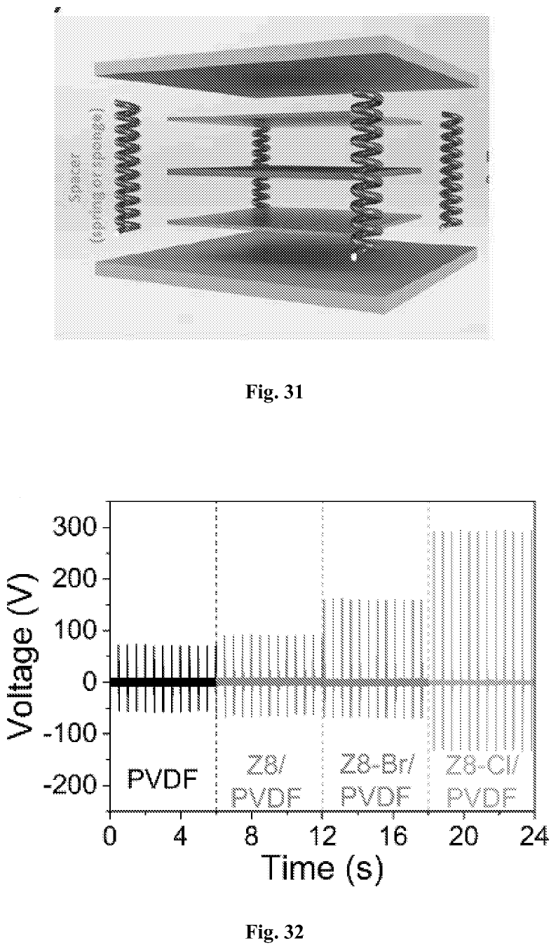

The synthesized nanoparticles are then incorporated into PVDF fiber by electrospinning technique as described above with schematic shown in FIG. 26. The fibre state is preferred by the casted type PDMS because a higher loading of MOF can be achieved without the formation of obvious aggregates. The SEM image of prepared ZIF-8-X/PVDF nanocomposite fibre is shown in FIG. 27. MOF particles with sizes of around 2 μm were observed on the PVDF fibres. The XRD pattern of composite fibre shown in FIG. 28 indicates retained crystallinity of ZIF-8-X nanoparticles, showing successful incorporation of MOF into fibre without further chemical interactions. The FTIR spectra of the prepared composite also shows evolution of peaks from ZIF-8-X nanoparticles at ~1140 cm⁻¹, as displayed in FIGS. 29 and 30, demonstrating the successful embedment of the fibre. The fabricated nanocomposite fibers show excellent flexibility and stability overall.

### Electrical Performance

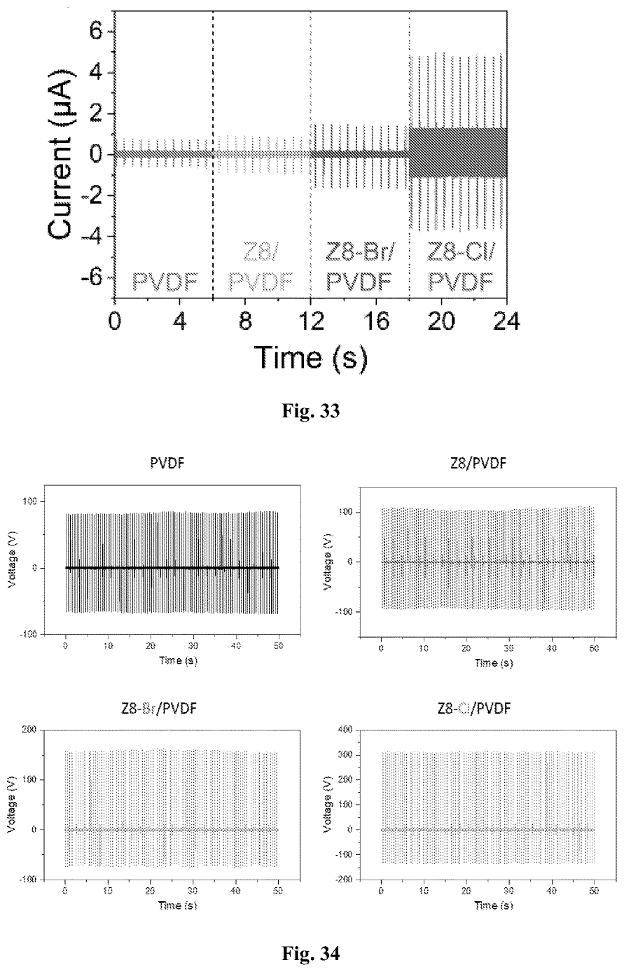

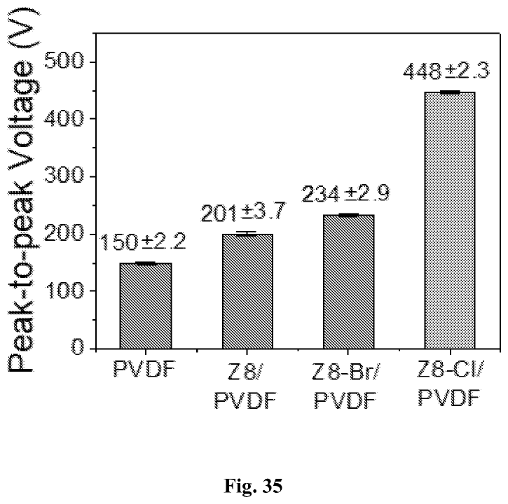

The electrical output of fabricated ZIF-8-X/PVDF fibers including open-circuit voltage and short-circuit current are measured and presented in FIGS. 32 and 33. With the same MOF loading of 5 wt % into PVDF, ZIF-8-Cl/PVDF generates the highest output of 293 V and 4.96 μA, which is 3.8 times and 5.5 times higher than the neat PVDF fibre, followed by ZIF-8-Br and ZIF-8. For peak-to-peak voltage, each sample was tested for 100 cycles (as shown in FIG. 34) and the average output and standard deviation were calculated and displayed in FIG. 35. There is an obvious trend that the triboelectric output of these MOF composites significantly differentiates according to the functional group. As expected, the conventional ZIF-8 having a methyl group linker has a partial positive charge low electronegativity which is not compatible with PVDF, only a minor change in electrical output. The slight improvement of the output performance might only be because of improved surface roughness. Moreover, since the methyl group is attached to an imidazole ring, it still exhibits some weak electron-withdrawing effect due to the inductive effect. As the functional groups get more electronegative, the voltage and current output gets higher.

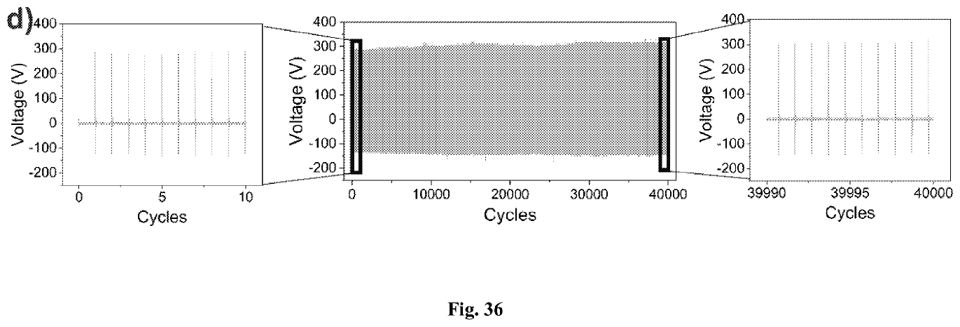

For each TENG device, the collected voltage and current are very stable, with minor fluctuation of output. To test the higher-level stability of the prepared samples, the same sample was tested under varying ambient temperature and humidity conditions, each with 12-hour intervals. The result also shows very good voltage output stability as shown in FIG. SX. Moreover, the long-term durability of Z8-Cl/PVDF-based TENG was also tested for over 40,000 cycles as demonstrated in FIG. 36. The prepared device maintained excellent output voltage during long testing cycles, showing great potential for real-world applications.

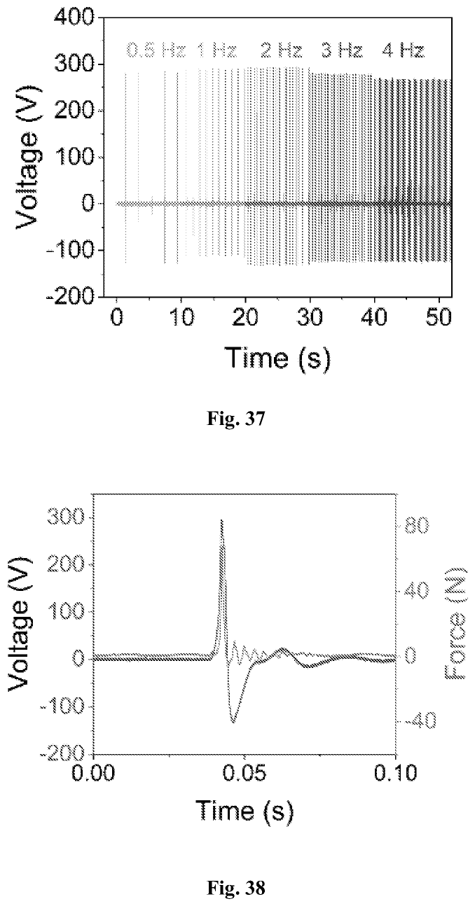

The frequency dependency of prepared TENG devices was also tested. From a testing frequency of 1 Hz to 4 Hz, there was no significant change in the output voltage as the frequency varies for each of the four types of TENG devices, as shown in FIG. 37. This is due to the same force applied on the material and the same displacement has been achieved, such that each individual impact can be considered as discrete, independent of frequency. Small reductions of output voltage were observed at higher frequencies which we attribute to the insufficient displacement during contact and separation.

Previous research studied the relationship between the electrical output of TENG and stabilized force, instead of the instantaneous peak force. In this case the applied force and output voltage were captured transiently and simultaneously using an integrated force sensor at one side of the TENG device during measurement. FIG. 38 shows the corresponding relationship between voltage and force on the same time scale. It has been found that for all materials, each contact and separation process only happen within 0.05 seconds. The voltage profile is very neat that the positive and negative voltage demonstrate the signal created during contact and separation respectively. It is worth noticing that the appearance of voltage happens slightly before the force is applied, which is at the point when two materials are still approaching, and no physical contact occurs yet. This finding supported the transfer of electrons during the contacting step. When the two triboelectric materials are approaching, the contact electrification process happens. However, the peak force and peak voltage occur at almost the same instance which implies that the voltage output has a strong correlation to the maximum force we applied. Once the force is unloaded, the negative voltage shows due to electrostatic induction. The most negative voltage occurs slightly after the force is completely unloaded, as the triboelectric layers are recovered to their fully separated state.

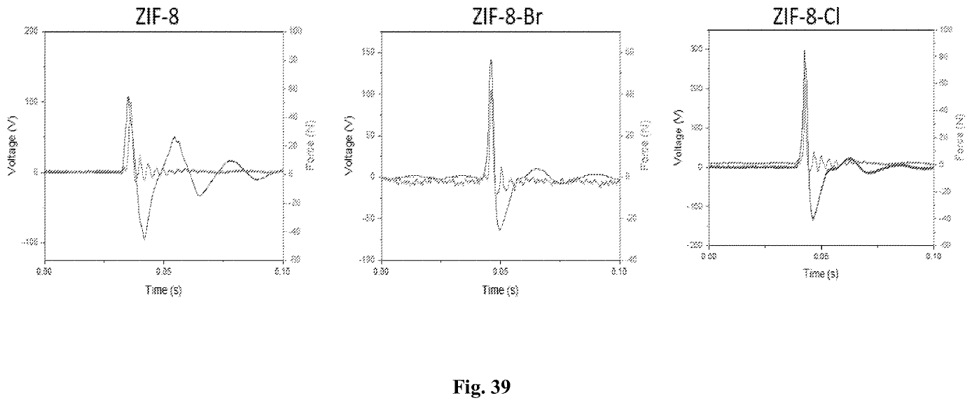

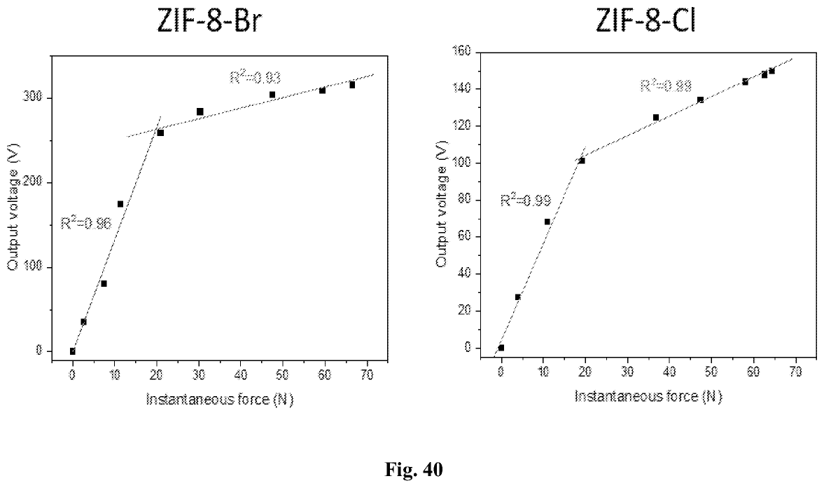

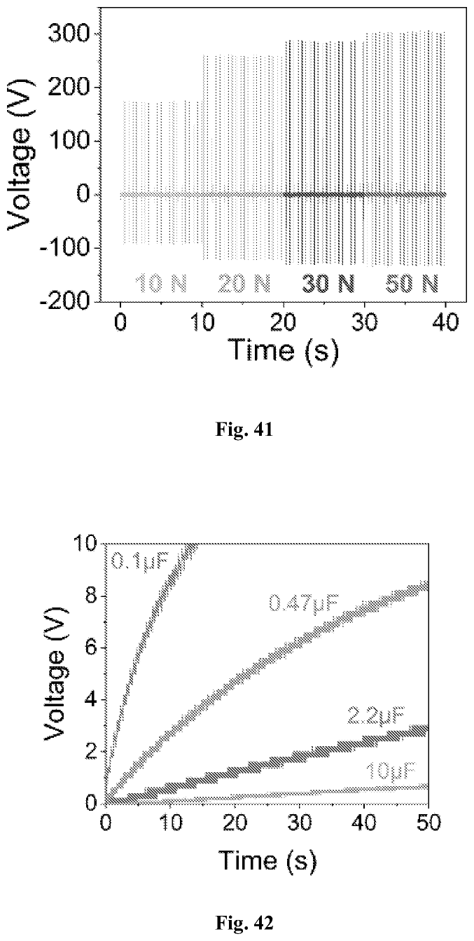

The relationship between the maximum instantaneous force and output voltage is recorded by varying the voltage input to our electromagnetic shaker. This reveals a non-linear correlation between force and voltage, which can be characterized as an exponential decay in that the sensitivity of measurement varies between the high- and low-pressure ranges. FIG. 39 displays the voltage-force relationships for each of the TENG devices we prepared. To illustrate the consistency of these correlations, FIG. 40 presents the raw voltage output profile at different forces. The devices demonstrate a clear and predictable trend between output voltage and force, suggesting their potential application as pressure or force sensors.

### Applications

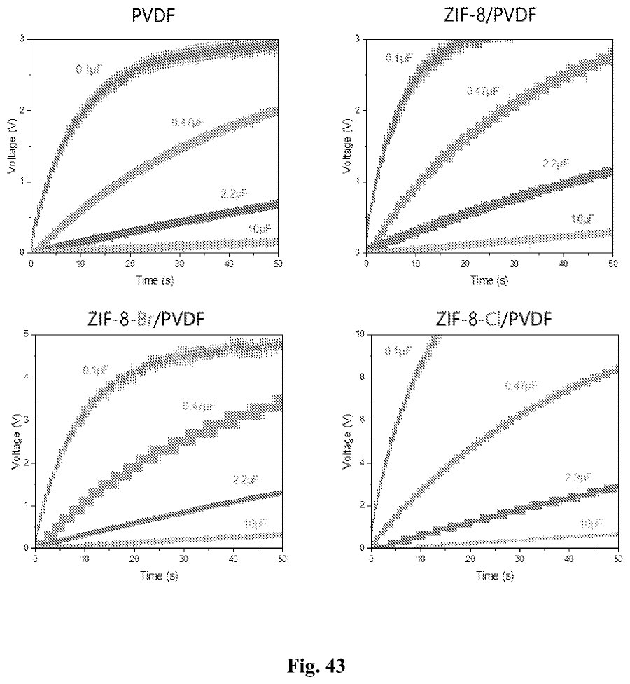

The alternating current produced by TENG was harvested and stored in capacitors through a full rectifier circuit to convert it into direct current. Then, the rectified current can be used to charge some commercial electronics such as calculators, LEDs, and capacitors. Here, several capacitors with capacitances ranging from 0.1 μF to 10 μF were charged by a steady 2 Hz oscillation motion on the ZIF-8-Cl/PVDF based TENG, as shown in FIG. 42. The capacitors can be easily charged up to a reasonably high voltage to power up small electronics. The same experiment was done on other prepared TENG devices, and the results are shown in FIG. 43.

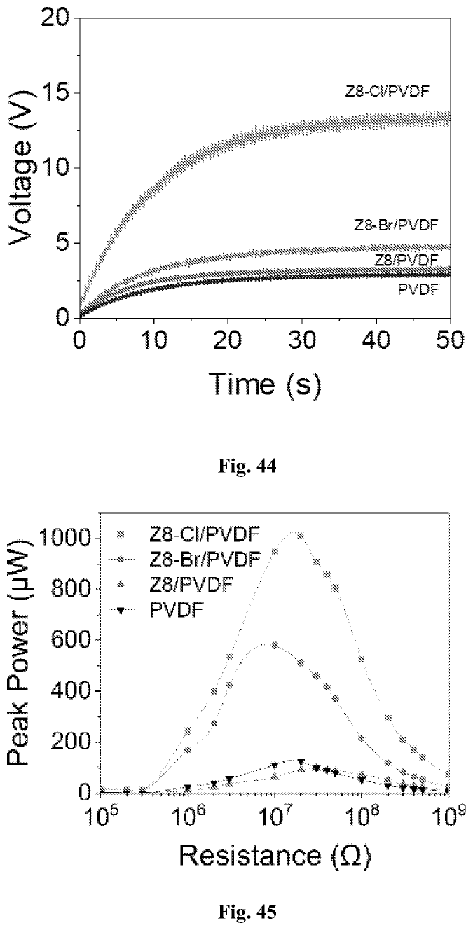

FIG. 44 compares the capabilities of different TENG devices for the charging a 0.1 F capacitor. It is clear that the ZIF-8-Cl/PVDF based TENG has exceptionally high charging ability compared to other materials, demonstrating excellent potential for energy harvesting. By calculation, 22 times more energy is harvested in a 0.1 μF capacitor within 50 seconds compared with pristine PVDF. The energy harvested through triboelectric displacement can be rectified and directly power some small electronics such as LEDs.

The prepared TENG devices are then connected to an external resistor to form a closed circuit. Here the closed-circuit voltage of each TENG is measured under different varying resistances from 100 kΩ to 2 GQ. Likewise to the capacitor charging correlation, the peak power density of Z8-Cl/PVDF based TENG is exterior to other devices, with an instantaneous power density of 1000 uW, 8.2 times higher than PVDF, as shown in FIG. 45.

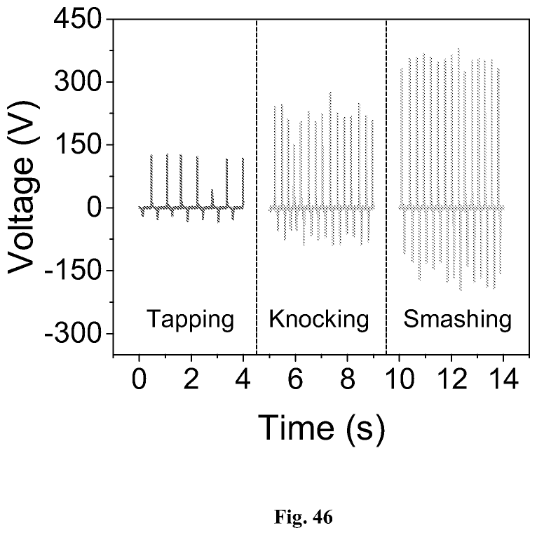

The prepared TENG devices were also subjected to various force strengths to demonstrate that they can be used to differentiate the magnitude of a force. The results are displayed in FIG. 46.

### Example 3

### Doctor Blade Coating

MOF/PVDF composites comprising ZIF-8, ZIF-8-Cl and ZIF-8—Br, were prepared by the doctor blade coating technique. The PVDF solution used for doctor blade coating was prepared by dissolving 13.7 wt % of HSV900 PVDF powder in DMF solution. The prepared ZIF-8-X nanoparticles were then mechanically mixed with PVDF solution to yield a mass ratio of 1:19 between ZIF-8-X and HSV900 PVDF powder.

The ZIF-8-X/PVDF solution mixture was dripped onto a glass substrate which had a sharp doctor blade at a fixed distance above the surface. The blade is then move in line with the surface to obtain a film with uniform thickness. The resultant coated substrate was then tested under contact separation mode.

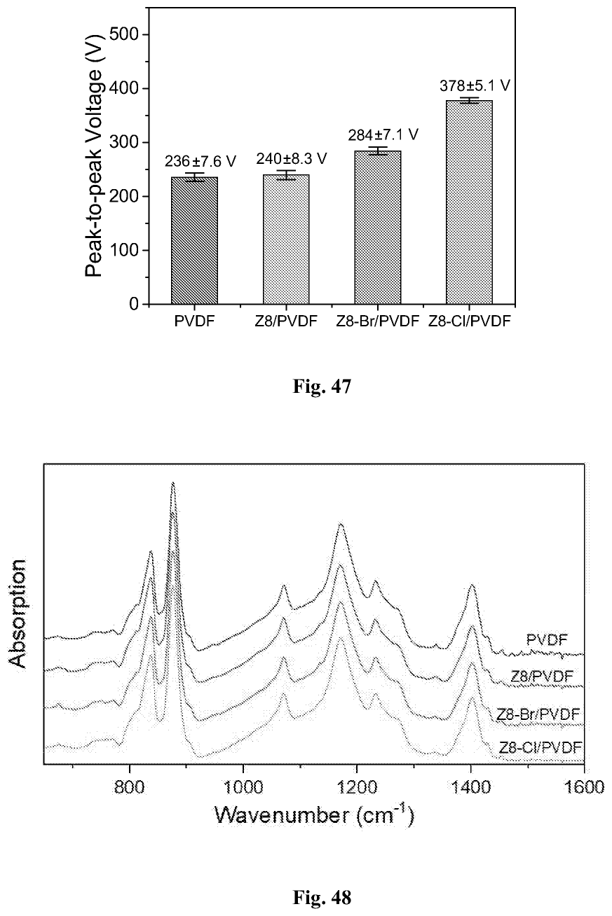

As can be seen in FIG. 47, the peak voltage achieved increased significantly with the Br and Cl modifications.

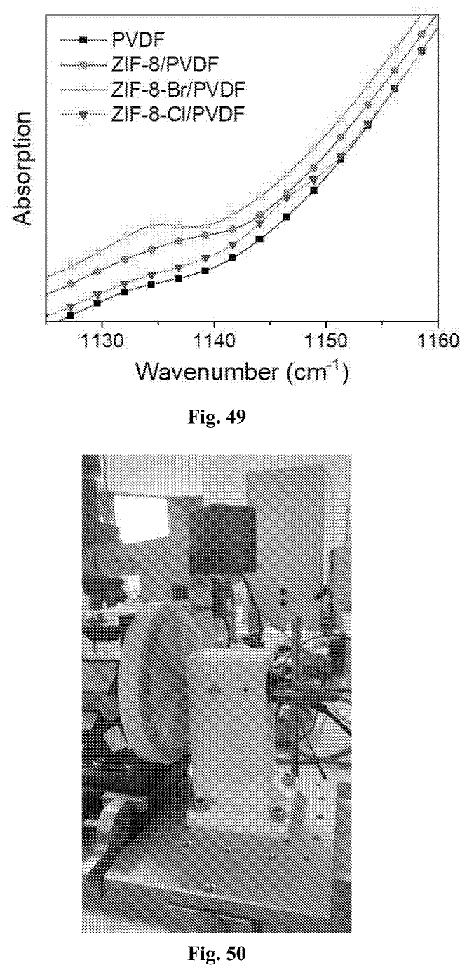

FTIR spectra of the ZIF-8-X/PVDF are shown in FIGS. 48 and 49.

### Rotary Design—Non-Contact Mode

A ZIF-8-Cl/PVDF casted substrate was prepared as described above.

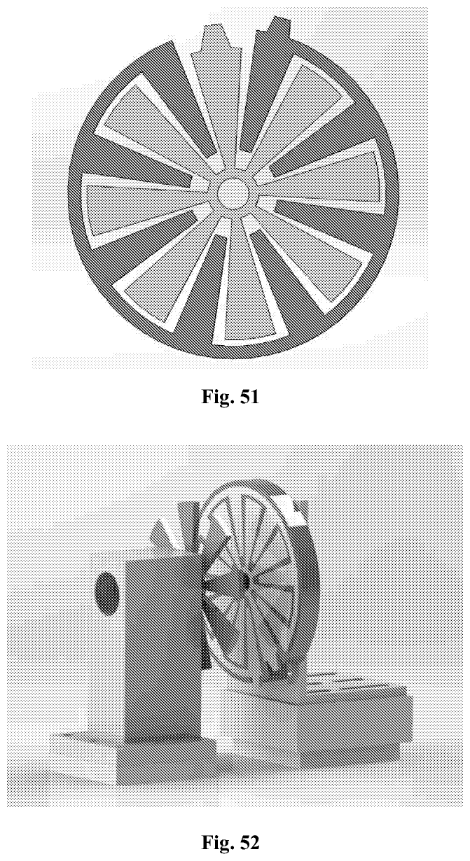

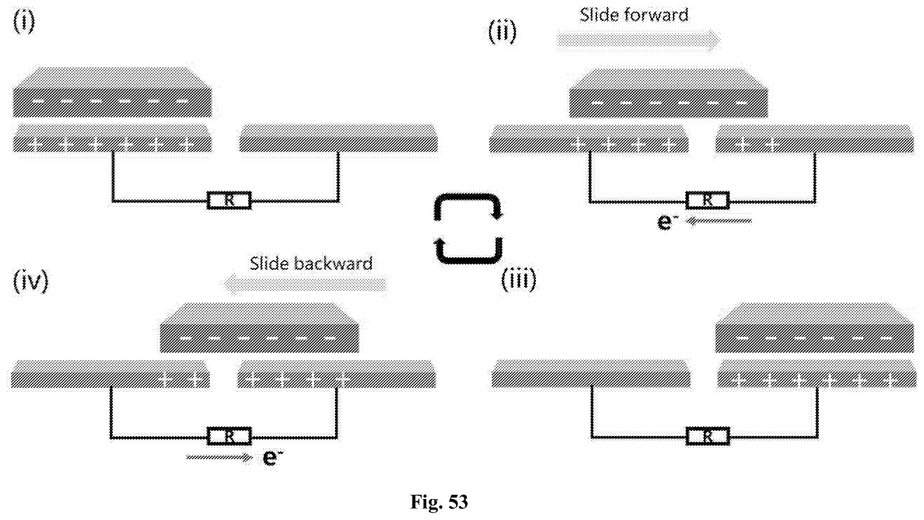

The casted substrate was arranged on a rotary device (as shown in FIGS. 50 to 52), to demonstrate the free-standing (i.e. non-contact) TENG mode (shown in FIG. 1(4) and FIG. 53).

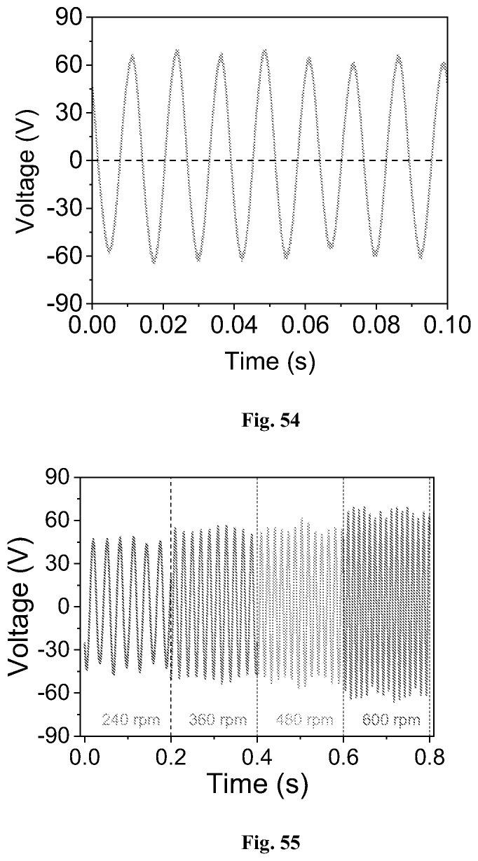

A voltage was generated by rotating the rotor at 600 rpm, as shown in FIG. 54.

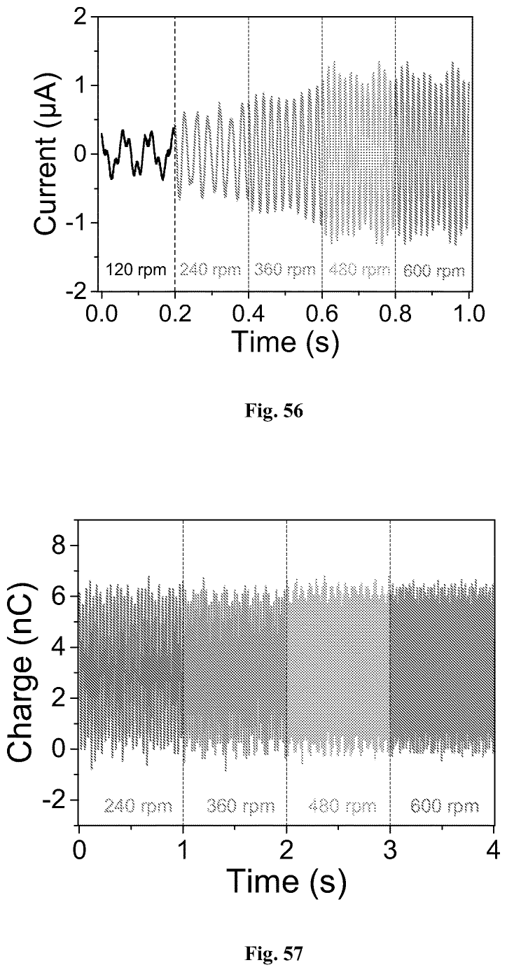

Voltage (FIG. 55), current (FIG. 56) and charge (FIG. 57) were all measured at various rotation speeds, demonstrating the tunability of the output using composites of the invention in the free-standing (i.e. non-contact mode) described herein. The gap between the tribo-negative element (i.e. the MOF/PVDF composition) and the tribo-positive element (i.e. the electrodes) was around 0.5 mm.

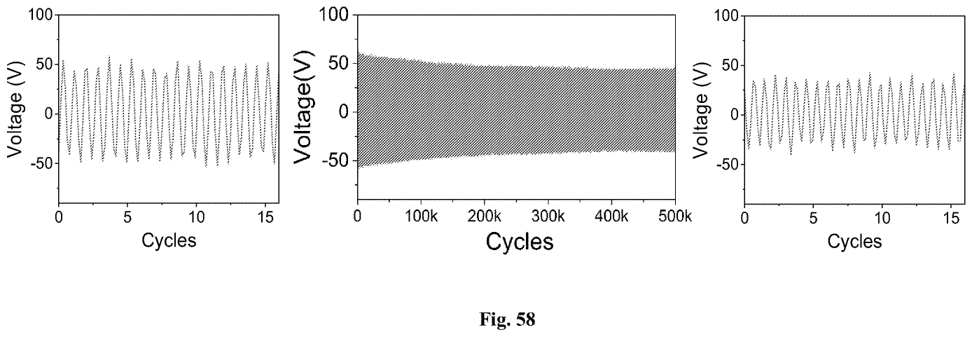

The long-term output stability of the composite used in this mode was also tested. As can be see in FIG. 58, a high voltage is still produced after 500,000 cycles.

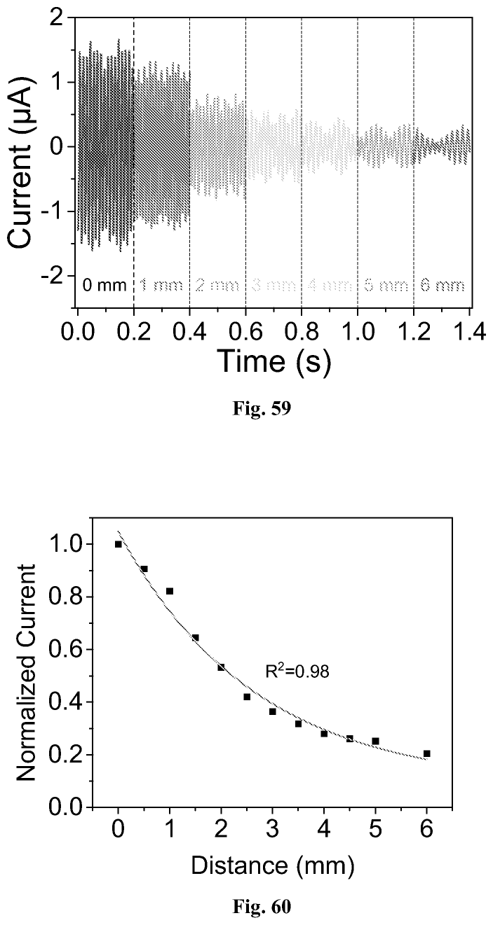

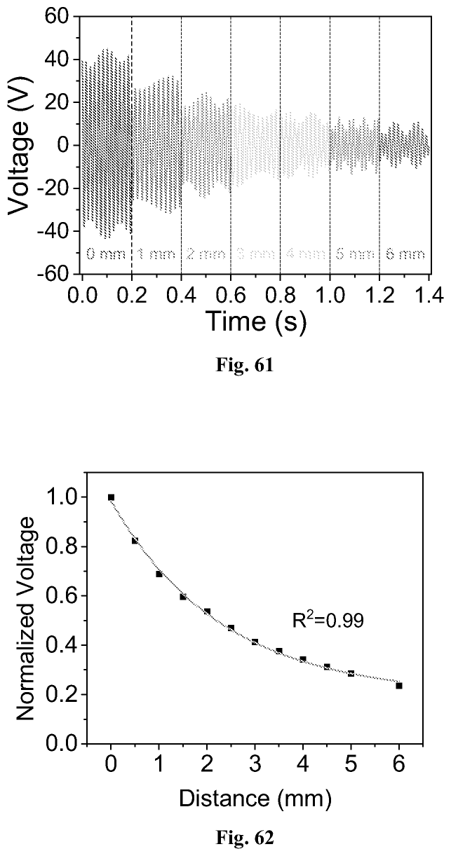

The current and voltage produced by a non-contact mode TENG can also be tuned by adjusting the distance between the MOF composite rotor and the electrode. In particular current (FIGS. 59 and 60) and voltage (FIGS. 61 and 62) reduce as the gap increases.

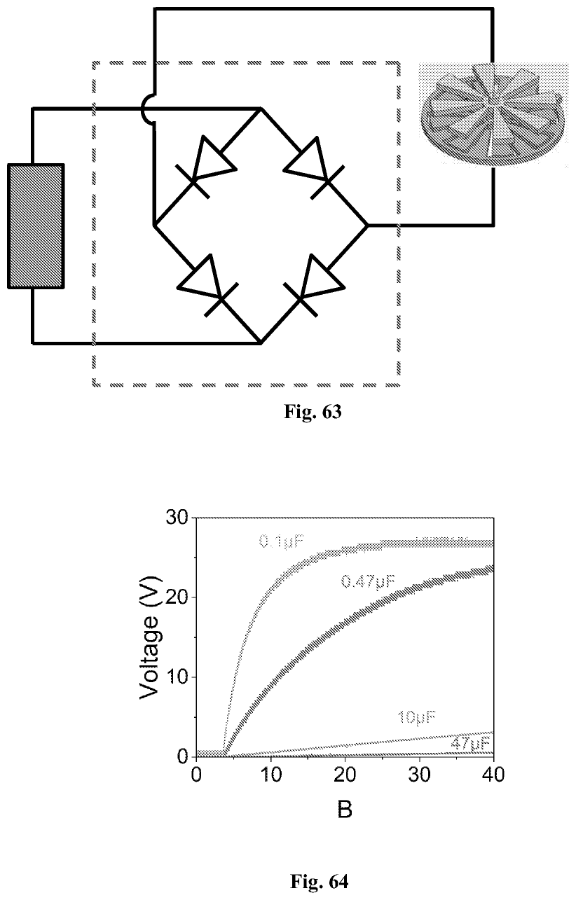

The rotary device, as described above, was used to provide continuous illumination of LEDs. The circuit is shown in FIG. 63. The human eye can only perceive around 60 Hz. Therefore, the rotary device of the invention (which can provide a voltage with an AC output around 80 Hz (see FIG. 54) can produce what appears as continuous illumination.

The voltage through various capacitors when included in a circuit connected to the rotary device described was also measured. The results are shown in FIG. 64. These results demonstrate how devices of the invention can be used to store harvested energy. The high operating frequency of the non-contacting rotary mode allows for high amounts of energy to be harvested per unit time.

Further aspects and embodiments of the invention are described in the following numbered paragraphs.
1. A transducer for converting mechanical or kinetic energy to electrical energy, wherein the transducer comprises a composite material, wherein the composite material comprises a polymer matrix and, dispersed in the matrix, a metal organic framework (MOF), wherein the metal organic framework comprises a metal ion and an organic linker, wherein the organic linker comprises one or more electronegative substituents.
2. A transducer according to paragraph 1 which is a triboelectric generator, wherein the triboelectric generator comprises
   a tribo-negative element; and
   a first electrode, arranged to receive charge resulting from relative movement between the tribo-negative element and a tribo-positive element,
   wherein the tribo-negative element comprises said composite material.
3. A transducer according to paragraph 2 wherein the triboelectric generator further comprises a counter-electrode.
4. A transducer according to paragraph 3 wherein the counter-electrode is said tribo-positive element.
5. A transducer according to paragraph 3 wherein the triboelectric generator further comprises said tribo-positive element, and the tribo-positive element is attached to the counter-electrode, optionally wherein the tribo-positive element is a dielectric material.
6. A transducer according to paragraph 4 or paragraph 5 wherein the relative movement comprises contacting the tribo-negative element with the tribo-positive element and separating the tribo-negative element from the tribo-positive element.
7. A transducer according to paragraph 4 or paragraph 5 wherein the relative movement comprises sliding a surface of the tribo-negative element against a surface of the tribo-positive element.
8. A transducer according to paragraph 7 wherein the sliding comprises lateral sliding or rotational sliding.
9. A transducer according to paragraph 2 wherein the triboelectric generator does not comprise a counter electrode, and wherein the triboelectric generator further comprises a reference electrode in electrical connection with the first electrode.
10. A transducer according to paragraph 9 wherein the tribo-positive element is not part of the triboelectric generator, optionally wherein the tribo-positive element is the surface of a rubber glove worn by an operator, or human skin.
11. A transducer according to paragraph 9 or paragraph 10, wherein the relative movement comprises contacting the tribo-negative element with the tribo-positive element and separating the tribo-negative element from the tribo-positive element.
12. A transducer according to paragraph 3 wherein the tribo-negative element is not in contact with the first electrode and is not in contact with the counter electrode, and the first electrode and the counter-electrode are the tribo-positive element, wherein the relative movement comprises moving the tribo-negative element relative to the first electrode and the counter-electrode to arrange the tribo-negative element alternately (i) closer towards the first electrode and further away from the counter-electrode, and (ii) closer towards the counter-electrode and further away from the first electrode.
13. A transducer according to any one of paragraphs 1 to 12, wherein the one or more electronegative substituents are independently selected from fluoro, chloro, bromo, C₁₋₄ fluoroalkyl, C₁₋₄ chloroalkyl, C₁₋₄ bromoalkyl, C₁₋₄ fluoroalkoxy, C₁₋₄ chloroalkoxy, CI.4 bromoalkoxy, a group of formula —OX, and a group of formula NXY, wherein X is H, F, Cl, or Br, and wherein Y is F, Cl, or Br; optionally wherein each of the one or more electronegative substituents is selected from chloro, fluoro and bromo, and preferably wherein each of the one or more electronegative substituents is chloro.
14. A transducer according to any one of paragraphs 1 to 13, wherein the one or more electronegative substituents are independently selected from fluoro, chloro, bromo, C₁₋₄ fluoroalkyl, C₁₋₄ chloroalkyl, C₁₋₄ bromoalkyl, C₁₋₄ fluoroalkoxy, C₁₋₄ chloroalkoxy, C₁₋₄ bromoalkoxy, and a group of formula NXY, wherein X is H, F, Cl, or Br, and wherein Y is F, Cl, or Br; optionally wherein each of the one or more electronegative substituents is selected from chloro, fluoro and bromo, and preferably wherein each of the one or more electronegative substituents is chloro.
15. A transducer according to any one of paragraphs 1 to 14, wherein the organic linker is an imidazole-based linker or a carboxylate ion linker, preferably wherein the organic linker is an imidazole-based linker, for instance an imidazolate linker or an imidazole linker.
16. A transducer according to paragraph 15 wherein the organic linker is an imidazole-based linker, wherein the imidazole-based linker is an imidazolate linker of formula (I) or an imidazole linker of formula (II):

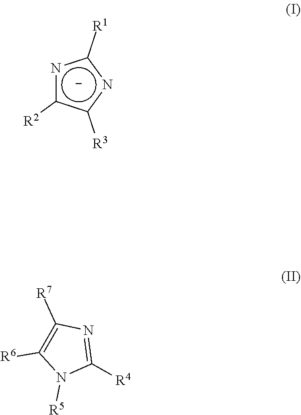

wherein, in formula (I):
R¹, R² and R³ are each independently selected from an electronegative substituent, hydrogen, C₁₋₁₀ alkyl, C₂₋₁₀ alkenyl, C₂₋₁₀ alkynyl and cyano, optionally wherein the electronegative substituent is as further defined in paragraph 13; provided that R² and R³ may be joined so as to form a substituted or unsubstituted ring, optionally wherein R² and R³ are joined to form a 5 or 6-membered ring, optionally wherein the ring comprises 1, 2 or 3 heteroatoms selected from O, N and S, and provided that any one of R¹, R² and R³ may be a hydrocarbon linker bonded to a further substituted or unsubstituted imidazolate ring or to a further substituted or unsubstituted imidazole ring;
wherein one or more of R¹, R² and R³ comprise said one or more electronegative substituents, preferably wherein one or more of R¹, R² and R³ are said one or more electronegative substituents;
and wherein, in formula (II):
R⁴, R⁵, R⁶ and R⁷ are each independently selected from an electronegative substituent, hydrogen, C₁₋₁₀ alkyl, C₂₋₁₀ alkenyl, C₂₋₁₀ alkynyl and cyano, optionally wherein the electronegative substituent is as further defined in paragraph 13; provided that R⁶ and R⁷ may be joined so as to form a substituted or unsubstituted ring, optionally wherein R⁶ and R⁷ are joined to form a 5 or 6-membered ring, optionally wherein the ring comprises 1, 2 or 3 heteroatoms selected from O, N and S, and provided that any one of R⁴, R⁵, R⁶ and R⁷ may be a hydrocarbon linker bonded to a further substituted or unsubstituted imidazolate ring or to a further substituted or unsubstituted imidazole ring;
wherein one or more of R⁴, R⁵, R⁶ and R⁷ comprise said one or more electronegative substituents, preferably wherein one or more of R⁴, R⁵, R⁶ and R⁷ are said one or more electronegative substituents.
17. A transducer according to paragraph 16 wherein the organic linker is:
   an imidazolate linker of formula (I) wherein R² and R³ are the one or more electronegative substituents, preferably wherein R¹ is H and R² and R³ are selected from chloro and fluoro; or
   an imidazole linker of formula (II), wherein R⁶ and R⁷ are the one or more electronegative substituents, preferably wherein R⁴ and R⁵ are both H, and R⁶ and R⁷ are selected from chloro and fluoro.
18. A transducer according to paragraph 17 wherein the organic linker is an imidazolate linker of formula (I) wherein R¹ is H and R² and R³ are both chlorine (4,5-dichloroimidazolate) or an imidazole linker of formula (II) wherein R⁴ and R⁵ are both H and R⁶ and R⁷ are both chlorine (4,5-dichloroimidazole),
   preferably wherein the organic linker is 4,5-dichloroimidazolate.
19. A transducer according to any one of the preceding paragraphs wherein the one or more metal ions comprise one or more metal ions of group 9, 10, 11, 12 or 14 of the periodic table, preferably wherein the metal ion is selected from Ag, Au, Cu, Zn, Co, Cd, Ir, Pt, P_{d} and Pb ions, more preferably wherein the metal ion is a Zn ion.
20. A transducer according to any one of paragraphs 15 to 19 wherein the metal organic framework is a zeolitic imidazolate framework (ZIF).
21. A transducer according to any one of the preceding paragraphs wherein the metal ion is a zinc ion and the organic linker is 4,5-dichloroimidazolate.
22. A transducer according to any one of the preceding paragraphs wherein the metal organic framework is obtainable by treating a solution of zinc acetate in a polar protic solvent with a solution of 4,5-dichloroimidazole in a polar protic solvent, under ambient conditions, and recovering the resulting precipitate,
   optionally wherein each polar protic solvent is an alcohol, for instance methanol, and optionally wherein the molar ratio of the 4,5-dichloroimidazole to the zinc acetate is from 6:1 to 2:1 and is preferably about 4:1.
23. A transducer according to any one of the preceding paragraphs wherein the metal organic framework is zeolitic imidazolate framework (ZIF) 71.
24. A transducer according to any one of the preceding paragraphs wherein the metal organic framework:
   is porous, preferably nanoporous, and more preferably comprises nanocrystals which are themselves porous; and/or
   has a density of less than 1.50 g cm⁻³, and preferably of from 1.00 g cm⁻³ to 1.30 g cm⁻³; and/or
   comprises nanocrystals having a rhombic dodecahedron shape; and/or
   has RHO topology; and/or
   is characterised by a powder X-ray diffraction pattern which comprises peaks at 2θ of 4.4°±0.2° and 7.6°±0.2°, measured using X-rays from a Cu Kα source having a wavelength of 1.541 Å; and/or
   is characterised by a Fourier transform infrared spectrum which comprises peaks at 1466 cm⁻¹±10 cm⁻¹ and 1202 cm⁻¹±10 cm⁻¹ but does not comprise peaks at 1414 cm⁻¹10 cm⁻¹ and 1350 cm⁻¹±10 cm⁻¹; and/or
   has a BET surface area of from 900 m²g⁻¹ to 1100 m²g⁻¹, preferably about 1015 m²g⁻¹; and/or
   has a void space of from 40% to 60% of the unit cell volume, for instance about 50% of the unit cell volume, wherein void space is preferably calculated using contact surface with a probe radius of 1.2 Å; and/or
   has a pore diameter of from 16.0 Å to 17.0 Å, for instance from 16.5 Å to 16.8 Å.
25. A transducer according to any one of paragraphs 1 to 21 wherein the metal organic framework is obtainable by heating a mixture of zinc oxide and 4,5-dichloroimidazole at a temperature of at least 100° C. in the absence of a solvent,
   optionally wherein the temperature is from about 120° C. to about 180° C. and is preferably about 150° C., and optionally wherein the molar ratio of the 4,5-dichloroimidazole to the zinc oxide is from 5:1 to 1:1 and is preferably about 3:1.
26. A transducer according to any one of paragraphs 1 to 21 and 25 wherein the metal organic framework is zeolitic imidazolate framework (ZIF) 72.
27. A transducer according to any one of paragraphs 1 to 21, 25 and 26 wherein the metal organic framework:
   is non-porous; and/or
   has a density of equal to or greater than 1.50 g cm⁻³, and preferably of from 1.60 g cm⁻³ to 1.90 g cm⁻³; and/or
   has LCS topology; and/or
   is characterised by a powder X-ray diffraction pattern which comprises peaks at 2θ of 12.7°±0.2° and 16.9°±0.2°, measured using X-rays from a Cu Kα source having a wavelength of 1.541 Å; and/or
   is characterised by a Fourier transform infrared spectrum which comprises peaks at 1466 cm⁻¹±10 cm⁻¹, 1414 cm⁻¹±10 cm⁻¹, 1350 cm⁻¹±10 cm⁻¹ and 1202 cm⁻¹±10 cm⁻¹; and/or
   has a void space of from 1% to 10% of the unit cell volume, for instance about 5%, wherein void space is preferably calculated using contact surface with a probe radius of 1.2 Å.
28. A transducer according to any of paragraph 1 to 16, 19 and 20 wherein the metal ion is a zinc ion and the organic linker is 2-bromoimidazolate or 2-chloroimidazolate.
29. A transducer according to any one of paragraphs 1 to 16, 19, 20 and 28 wherein the metal organic framework is obtainable by heating a mixture comprising zinc nitrate and 2-bromo-1H-imidazole or 2-chloro-1H-imidazole in a polar protic solvent, optionally to a temperature of about 100° C. or greater than 100° C., and recovering the resulting precipitate,
   optionally wherein the polar protic solvent is an alcohol, for instance ethanol, and optionally wherein the molar ratio of the 2-bromo-1H-imidazole or 2-chloro-1H-imidazole to the zinc nitrate is from 6:1 to 1:1 and is preferably about 2:1.
30. A transducer according to any one of the preceding paragraphs wherein the polymer matrix comprises a hydrophobic polymer, optionally wherein the polymer matrix comprises a polysiloxane, a polyvinylidene fluoride (PVDF), a polystyrene (PS) or a polyimide (PI), preferably wherein polymer matrix comprises a polysiloxane, preferably wherein the polysiloxane is polydimethylsiloxane (PDMS).
31. A transducer according to any one of the preceding paragraphs wherein particles of the metal organic framework are dispersed throughout the polymer matrix.
32. A transducer according to any one of the preceding paragraphs wherein the metal organic framework has a mean particle size of from 0.2 μm to 1.8 μm, optionally from 0.5 μm to 1.5 μm, for instance about 1 μm.
33. A transducer according to any one of the preceding paragraphs wherein the amount of the metal organic framework in the composite material is less than or equal to 5 wt % based on the total weight of the composite material, preferably wherein the amount of the metal organic framework in the composite material is less than or equal to 3 wt %.
34. A transducer according to any one of paragraphs 1 to 21 wherein the polymer matrix comprises PDMS, the metal organic framework is as defined in any one of paragraphs 22 to 24, and the amount of the metal organic framework in the composite material is from 1.5 wt % to 2.5 wt % based on the total weight of the composite material, preferably from 1.8 wt % to 2.2 wt %, for instance about 2 wt %.
35. A transducer according to any one of paragraphs 1 to 21 wherein the polymer matrix comprises PDMS, the metal organic framework is as defined in any one of paragraphs 25 to 27, and the amount of the metal organic framework in the composite material is from 0.5 wt % to 1.5 wt % based on the total weight of the composite material, preferably from 0.8 wt % to 1.2 wt %, for instance about 1 wt %.
36. A transducer according to any one of paragraphs 1 to 16, 19 and 20 wherein the polymer matrix comprises PVDF, the metal organic framework is as defined in any one of paragraphs 28 and 29, and, optionally, the amount of the metal organic framework in the composite material is from 0.5 wt % to 15 wt % based on the total weight of the composite material, preferably from 3 wt % to 8 wt %, for instance about 5 wt %, and optionally wherein the composite material comprises electrospun fibres comprising said polymer matrix and, dispersed in the matrix, said metal organic framework.
37. A composite material which comprises a polymer matrix and, dispersed in the matrix, a metal organic framework, wherein the metal organic framework comprises a metal ion and an organic linker, wherein the organic linker comprises one or more electronegative substituents.
38. A composite material according to paragraph 37 wherein the composite material is as further defined in any one of paragraphs 13 to 36.
39. An electrical generator which comprises a transducer as defined in any one of paragraphs 1 to 36.
40. A product which comprises an electrical generator as defined in paragraph 39, wherein the product is an electronic device, for instance a wearable electronic device, microelectronics, a humidity thermometer, a digital timer, or a calculator; a charging device, for instance a phone charger; a capacitor; a light emitting diode; a transmitter, for instance a Bluetooth transmitter.
41. An electrical generator which comprises a transducer as defined in paragraph 7 wherein the sliding comprises rotational sliding, and wherein the relative movement is caused by wind and/or wave, optionally wherein the relative movement is caused by wind, and the wind is generated by a passing vehicle, for instance a train.
42. A device comprising an electrical generator which comprises a transducer as defined in paragraph 7 wherein the sliding comprises rotational sliding, and wherein the device is a machine capable of rotary motion, optionally a washing machine, tumble dryer, or combined washer dryer.
43. A device comprising an electrical generator which comprises a transducer as defined in paragraph 12 wherein said moving comprises rotational movement and the device is a machine capable of rotary motion, for instance a washing machine, tumble dryer, or combined washer dryer.
44. A sensor which comprises a transducer as defined in any one of paragraphs 1 to 36.
45. A sensor according to paragraph 44 which is a force sensor, a contact sensor, a proximity sensor, a movement sensor, a motion sensor, a pedometer, a tactile sensor, a tactile sensor for soft robots, or a sensor for a wearable device, optionally wherein said sensor is flexible.
46. A sensor according to paragraph 44 or paragraph 45 which is a self-powered sensor.
47. A product which comprises at least one transducer as defined in any one of paragraphs 1 to 36, wherein the product is a keyboard, a morse code generator, a dance floor, sportswear, a biomedical implant, or a prosthetic, optionally wherein the product is self-powered.
48. A gas filtration device which comprises a composite material as defined in paragraph 37 or paragraph 38.
49. A water purification device which comprises a composite material as defined in paragraph 37 or paragraph 38.
50. A catalyst which comprises a composite material as defined in paragraph 37 or paragraph 38.
51. A luminescent device which comprises a composite material as defined in paragraph 37 or paragraph 38.
52. A method of operating a triboelectric generator as defined in any one of paragraphs 2 to 12, which method comprises causing the relative movement between the tribo-negative element and the tribo-positive element, in order to generate a potential difference between them due to a triboelectrification effect.

1. A transducer for converting mechanical or kinetic energy to electrical energy, wherein the transducer comprises a composite material, wherein the composite material comprises a polymer matrix and, dispersed in the matrix, a metal organic framework (MOF), wherein the metal organic framework comprises a metal ion and an organic linker, wherein the organic linker comprises one or more electronegative substituents.

2. A transducer according to claim 1 which is a triboelectric generator, wherein the triboelectric generator comprises
a tribo-negative element; and
a first electrode, arranged to receive charge resulting from relative movement between the tribo-negative element and a tribo-positive element,
wherein the tribo-negative element comprises said composite material.

3. A transducer according to claim 2 wherein the triboelectric generator further comprises a counter-electrode.

4. A transducer according to claim 3 wherein:
(the counter-electrode is said tribo-positive element; or
(B) the triboelectric generator further comprises said tribo-positive element, and the tribo-positive element is attached to the counter-electrode, optionally wherein the tribo-positive element is a dielectric material.

5. (canceled)

6. A transducer according to claim 4 wherein:
(A) the relative movement comprises contacting the tribo-negative element with the tribo-positive element and separating the tribo-negative element from the tribo-positive element; or
(B) the relative movement comprises sliding a surface of the tribo-negative element against a surface of the tribo-positive element.

7-8. (canceled)

9. A transducer according to claim 3 wherein the tribo-negative element is not in contact with the first electrode and is not in contact with the counter electrode, and the first electrode and the counter-electrode are the tribo-positive element, wherein the relative movement comprises moving the tribo-negative element relative to the first electrode and the counter-electrode to arrange the tribo-negative element alternately (i) closer towards the first electrode and further away from the counter-electrode, and (ii) closer towards the counter-electrode and further away from the first electrode.

10. A transducer according to claim 1, wherein
the one or more electronegative substituents are independently selected from fluoro, chloro, bromo, C₁₋₄ fluoroalkyl, C₁₋₄ chloroalkyl, C₁₋₄ bromoalkyl, C₁₋₄ fluoroalkoxy, C₁₋₄ chloroalkoxy, C₁₋₄ bromoalkoxy, and a group of formula NXY, wherein X is H, F, Cl, or Br, and wherein Y is F, Cl, or Br.

11. A transducer according to claim 1, wherein the composite material comprises electrospun fibres, which electrospun fibres comprise: said polymer matrix and, dispersed in the matrix, said MOF.

12-13. (canceled)

14. A transducer according to claim 1 wherein the metal ion is a zinc ion and the organic linker is 4,5-dichloroimidazolate or 2-bromoimidazolate or 2-chloroimidazolate.

15. A transducer according to claim 1 wherein the metal organic framework is obtainable by:
(A) treating a solution of zinc acetate in a polar protic solvent with a solution of 4,5-dichloroimidazole in a polar protic solvent, under ambient conditions, and recovering the resulting precipitate;
(B) heating a mixture of zinc oxide and 4,5-dichloroimidazole at a temperature of at least 100° C. in the absence of a solvent; or
(C) heating a mixture comprising zinc nitrate and 2-bromo-1H-imidazole or 2-chloro-1H-imidazole in a polar protic solvent, optionally to a temperature of about 100° C. or greater than 100° C., and recovering the resulting precipitate.

16-20. (canceled)

21. A composite material which comprises a polymer matrix and, dispersed in the matrix, a metal organic framework, wherein the metal organic framework comprises a metal ion and an organic linker, wherein the organic linker comprises one or more electronegative substituents.

22. An electrical generator which comprises a transducer as defined in claim 1.

23. A product which comprises an electrical generator as defined in claim 22, wherein the product is an electronic device, optionally a wearable electronic device, microelectronics, a humidity thermometer, a digital timer, a calculator; a charging device; a capacitor; a light emitting diode; or a transmitter.

24. An electrical generator which comprises transducer as defined in claim 4 wherein the relative movement comprises sliding a surface of the tribo-negative element against a surface of the tribo-positive element and wherein the sliding comprises rotational sliding, and wherein the relative movement is caused by wind and/or wave, optionally wherein the relative movement is caused by wind, and the wind is generated by a passing vehicle.

25. A sensor which comprises a transducer as defined in claim 1.

26. A product which comprises at least one transducer as defined in claim 1, wherein the product is a keyboard, a morse code generator, a dance floor, sportswear, a biomedical implant, or a prosthetic, optionally wherein the product is self-powered.

27. A gas filtration device, a water purification device, a catalyst or a luminescent device, which comprises a composite material as defined in claim 21.

28. A method of operating a triboelectric generator as defined in claim 2, which method comprises causing the relative movement between the tribo-negative element and the tribo-positive element, in order to generate a potential difference between them due to a triboelectrification effect.

29. A device comprising an electrical generator which comprises a transducer as defined in claim 4 wherein the relative movement comprises sliding a surface of the tribo-negative element against a surface of the tribo-positive element and wherein the sliding comprises rotational sliding, and wherein the device is a machine capable of rotary motion, optionally a washing machine, tumble dryer, or combined washer dryer.

30. A device comprising an electrical generator which comprises a transducer as defined in claim 9 wherein said moving comprises rotational movement and the device is a machine capable of rotary motion, for instance a washing machine, tumble dryer, or combined washer dryer.
